(19) United States
(12) Patent Application Publication
(10) Pub. No.: US 2026/0300976 A1
(43) Pub. Date: Oct. 1, 2026

(54) TRANSMISSION AUTHORIZATIONS IN DATA TRANSMISSION SYSTEMS

(71) Applicant: 1Money Co., New York, NY (US)

(72) Inventors: Laurent Bindschaedler, Saarbrücken (DE); Brian Walker Shroder, Incline Village, NV (US)

(21) Appl. No.: 19/219,711

(22) Filed: May 27, 2025

Related U.S. Application Data
(60) Provisional application No. 63/780,847, filed on Mar. 31, 2025.

(51) Int. Cl. G06Q 20/40; G06Q 20/38; H04L 9/32

(52) U.S. Cl. CPC G06Q 20/401; G06Q 20/38215; G06Q 20/3825; H04L 9/3247; H04L 9/3268

(57) ABSTRACT

Some embodiments relate to techniques for asynchronously allowing an authorizing user of a data transmission system to authorize another user to perform transmissions from the authorizing user. The data transmission system including validation units for validating transmissions among users of the data transmission system, the method including. A device may transmit, to the validation units, an authorization for a first user to trigger transmissions in the data transmission system from a second user. The device may receive validation messages indicating that the authorization for the first user to perform transmissions from the second user is valid. When validation messages are received from at least a threshold number of the validation units, the first user is granted the authorization to trigger transmissions from the second user.

### RELATED APPLICATIONS

This application claims the benefit under 35 U.S.C. § 119(e) of U.S. Provisional Application Ser. No. 63/780,847, filed Mar. 31, 2025, and entitled “TRANSMISSION AUTHORIZATIONS IN DATA TRANSMISSION SYSTEMS,” which is hereby incorporated herein by reference in its entirety.

### BACKGROUND

Data transmissions systems (e.g., a cryptographic transmission system) may have a large number (e.g., thousands or millions) of users. The users may make transmission to each other. For example, a data transmission system may allow users to transmit units of a cryptocurrency to each other. The data transmission system may provide a network through which transactions (e.g., purchases) may be performed between users through data transmissions.

### SUMMARY

Some embodiments described herein relate to techniques for users to authorize other users to trigger transmissions on their behalf in a data transmission system. The data transmission system may, for example, be a cryptographic transmission system. The data transmission system includes validation units that validate transmissions. Authorizations may be granted based on validation of the authorizations by the validation units. Accordingly, the authorizations may be granted asynchronously by broadcasting to the validation units. When a first user is granted an authorization by a second user, the first user may trigger transmissions in the data transmission system on behalf of the second user.

A cryptographic transmission system (e.g., implemented as a Layer 1 (L1)) may be a Byzantine-fault tolerant protocol with sybil protection (e.g. proof-of-stake or proof-of-authority, i.e. permissioned validators) and incentive compatibility mechanisms for validators (e.g. share of transaction fees, money generation) that is used for confirming payment transactions. Some embodiments may use a blockchain such as Ethereum (with smart contracts disabled). Some embodiments may use a broadcast-based transmission system. A unified transmission medium may be used as a medium in which to distribute transmission fees (e.g., as a native gas token) and to represent amounts of resources belonging to users. In some embodiments, each user may have multiple balances of the unified transmission medium, and transmission fees would always be charged in the corresponding currency.

It allows users to hold multiple resources (e.g., currencies) in the same cryptographic transmission system. This becomes particularly interesting when it is coupled with an exchange mechanism between resources (e.g., with atomic settlement). Being able to transmit multiple resources is interesting for a variety of reasons, and it becomes even more interesting when you consider that a resource does not need to refer to fiat currencies but could also refer to any asset.

Conventional cryptographic transmission systems may be based on cryptocurrencies, i.e. a newly created asset with no intrinsic value other than being used to pay transmission fees. Offering multiple resource transmission would be a detraction from the core value proposition of their cryptocurrency, because they would have to justify the value of multiple assets. Some embodiments use a stablecoin-based cryptographic transmission system, where the intrinsic value of the transmission medium is independent of the cryptographic transmission system. Some embodiments may provide the ability to execute smart contracts as part of the core value proposition as well. The execution itself may not have anything to do with the unified transmission medium. In such situations, offering multiple resources (e.g., gas tokens) would create arbitrage opportunities, as users could choose the transmission where transmission fees have the currently lowest real-word value.

Some embodiments use a centralized design where a central operator registers the available amounts of a unified transmission medium. For each resource a system with authority to create new amounts of the unified transmission medium, and/or a set of rules governing how additional amounts of the unified transmission medium may be issued (e.g. following confirmation of a proof-of-ownership). The set of resources may be indicated by a governance parameter and can be changed in governance parameter updates.

Each transmission may specify the resource to be used, and validators check the balance of the unified transmission medium representing the resource. Some embodiments may use an L1 that uses an account model (e.g., Ethereum) instead of UTXOs (e.g., as in Bitcoin). In the account model, each user account has a nonce, i.e. a (strictly increasing) transmission counter. There could be one nonce for all resources or one nonce per resource (multiple embodiments). Multiple nonces may allow parallel processing of transmissions of different resources.

Some embodiments provide a method for asynchronously allowing a user of a data transmission system to authorize another user to perform transmissions of a uniform transmission medium (UTM) from a UTM balance of the user, the data transmission system including validation units for validating transmissions among users of the data transmission system, the method including: using at least one processor to perform: transmitting, to the validation units, an authorization for a first user to trigger UTM transmissions in the data transmission system from a UTM balance of a second user; receiving, from at least some of the validation units, validation messages indicating that the authorization for the first user to perform UTM transmissions from the UTM balance of the second user is valid, wherein: when validation messages are received from at least a threshold number of the validation units, the first user is granted the authorization to trigger UTM transmissions from the UTM balance of the second user.

Some embodiments provide a non-transitory storage medium storing instructions that, when executed by at least one processor, cause the at least one processor to perform a method for asynchronously allowing a user of a data transmission system to authorize another user to perform transmissions of a uniform transmission medium (UTM) from a UTM balance of the user, the data transmission system including validation units for validating transmissions among users of the data transmission system, the method including: transmitting, to the validation units, an authorization for a first user to trigger UTM transmissions in the data transmission system from a UTM balance of a second user; receiving, from at least some of the validation units, validation messages indicating that the authorization for the first user to perform UTM transmissions from the UTM balance of the second user is valid, wherein: when validation messages are received from at least a threshold number of the validation units, the first user is granted the authorization to trigger UTM transmissions from the UTM balance of the second user.

Some embodiments provide a system for asynchronously allowing a user of a data transmission system to authorize another user to perform transmissions of a uniform transmission medium (UTM) from a UTM balance of the user, the data transmission system including validation units for validating transmissions among users of the data transmission system, the system including: at least one processor; and a non-transitory computer-readable storage medium storing instructions that, when executed by the at least one processor, cause the at least one processor to: transmit, to the validation units, an authorization for a first user to trigger UTM transmissions in the data transmission system from a UTM balance of a second user; receive, from at least some of the validation units, validation messages indicating that the authorization for the first user to perform UTM transmissions from the UTM balance of the second user is valid, wherein: when validation messages are received from at least a threshold number of the validation units, the first user is granted the authorization to trigger UTM transmissions from the UTM balance of the second user. The foregoing summary is non-limiting.

### BRIEF DESCRIPTION OF DRAWINGS

The accompanying drawings, which are incorporated in and constitute a part of this specification, illustrate an implementation of the present invention and, together with the description, serve to explain the advantages and principles of the invention. In the drawings:

FIG. 1 depicts one embodiment of a payment management system 100 consistent with the present invention, according to some embodiments of the technology described herein.

FIG. 2 depicts one embodiment of a payment management unit, according to some embodiments of the technology described herein.

FIG. 3 depicts one embodiment of a communication device 104/106 consistent with the present invention, according to some embodiments of the technology described herein.

FIG. 4 depicts a schematic representation of the broadcast system for the payment management system, according to some embodiments of the technology described herein.

FIG. 5 depicts a schematic representation of a system of processing a payment request, according to some embodiments of the technology described herein.

FIG. 6 depicts the schematic representation of a recovery process, according to some embodiments of the technology described herein.

FIG. 7 is a schematic representation of a payment transaction, according to some embodiments of the technology described herein.

FIG. 8 depicts the schematic representation of a checkpoint creation process, according to some embodiments of the technology described herein.

FIG. 9 depicts a schematic representation of a process for creating a governance certificate, according to some embodiments of the technology described herein.

FIG. 10 is a schematic representation of a payment system, according to some embodiments of the technology described herein.

FIG. 11 depicts a schematic representation of a ledger system, according to some embodiments of the technology described herein.

FIG. 12 depicts a schematic representation of a minting process for a token, according to some embodiments of the technology described herein.

FIG. 13 depicts a schematic representation of a settlement process, according to some embodiments of the technology described herein.

FIG. 14A depicts an example validator (also referred to herein as a “validation unit”) of a cryptographic transmission system for transmission of multiple different resources, according to some embodiments of the technology described herein.

FIG. 14B depicts an example validation of a requested transmission in a cryptographic transmission system comprising a network of validators configured as depicted in FIG. 14A, according to some embodiments of the technology described herein.

FIG. 14C depicts operation of a validator in validating the requested transmission of FIG. 14B, according to some embodiments of the technology described herein.

FIG. 15 depicts the issuance of a uniform transmission medium to users of a cryptographic transmission system, according to some embodiments of the technology described herein.

FIG. 16 depicts an example process for transmitting one or more resources using a cryptographic transmission system, according to some embodiments of the technology described herein.

FIG. 17A depicts an example data transmission system in which users can authorize other users to perform transmissions on their behalf, according to some embodiments of the technology described herein.

FIG. 17B depicts an example validator in the data transmission system of FIG. 17A, according to some embodiments of the technology described herein.

FIG. 18 shows a flowchart of an example process for validators of a data transmission system to grant an authorization for a first user to perform transmissions on behalf of a second user, according to some embodiments of the technology described herein.

FIG. 19 shows a flowchart of an example process for a user of a data transmission system to authorize another user to perform transmissions on behalf of the user, according to some embodiments of the technology described herein.

FIG. 20A illustrates a flow of an example authorization that is granted by an authorizing user and then used to trigger a transmission by the authorized user, according to some embodiments of the technology described herein.

FIG. 20B illustrates a flow of an example authorization that is granted and then revoked, according to some embodiments of the technology described herein.

FIG. 21A illustrates a flow of an example authorization that is granted and then used to trigger a transmission, according to some embodiments of the technology described herein.

FIG. 21B illustrates a flow of an example authorization that is renewed and then canceled, according to some embodiments of the technology described herein.

FIG. 22 is an example computer system that may be specially configured to perform embodiments of the technology described herein.

### DETAILED DESCRIPTION

Described herein is a data transmission system such as a cryptographic transmission system and associated techniques for transmission of resources. The cryptographic transmission system is a broadcast-based system in which transmission requests are asynchronously validated by a network of validation units.

The inventors have developed a cryptographic transmission system that can validate a transmission more quickly than conventional systems that rely on consensus among validators while offering the same level of security guarantees. Techniques described herein may provide Byzantine fault tolerance (BFT) without needing validators to reach a full consensus. For example, the cryptographic transmission system may finalize 100,000 transmissions per second at 100 ms latency until finality.

Consensus-based validation in transmission systems requires that, for each transmission, a consensus is reached among validators to determine the validity of the transmission. The consensus provides a high level of decentralized security and reliability for transmission validation and recording. However, consensus among validation units involves long processing times due to the communication and coordination needed to reach consensus. For example, the commonly used proof-of-work and proof-of-stake algorithms require long processing times to achieve consensus among a set of validators. Conventional systems may also apply ordering to transmissions, which further lengthens processing times for validation.

The inventors have developed a cryptographic transmission system that does not rely on consensus to achieve BFT. Additionally, the system does not apply ordering to transmissions. This allows the system to achieve finality faster than consensus-based systems while providing equivalent levels of cryptographic security. The cryptographic transmission system validates transmissions without needing validation units to communicate and coordinate with each other (as required for consensus). The cryptographic transmission system employs an asynchronous validation technique in which a message requesting a transmission is broadcast to a network of validators. Each validator performs validation independently of the other validators. For example, in some embodiments, as soon as a threshold number of validation units have communicated that the transmission is valid, the transmission may be executed. The system does not require any staking, slashing, or proof-of-work. Further, the system does not involve the ordering of transmissions. This allows the system to validate a transmission with a single broadcast to the network of validation units and eliminates the need for the network of validation units to communicate with one another to determine an ordering of transmissions.

The cryptographic transmission system may utilize a unified transmission medium (UTM) to transmit resources between users. The UTM may be data stored in memory that provides a digital representation of a resource belonging to a user. The cryptographic transmission system may store balances of the UTM for the users. A UTM balance of a user may represent an amount of a particular resource (e.g., currency, financial instrument, fungible goods, or other resource) that belongs to the user. For example, the UTM used by the cryptographic transmission system may be a digital token. Tokens may be issued to a user to represent an amount of a resource belonging to the user. For example, the cryptographic transmission system may receive, from an external system, an amount of a resource belonging to the user. The cryptographic transmission system may issue a corresponding amount of the UTM to the user that can be used to transmit amounts of the resource to other users. The UTM used by the cryptographic transmission system may not have inherit value, unlike cryptocurrencies such as Bitcoin. Rather, the UTM is used by the cryptographic transmission system as an electronic representation of a resource that enables efficient and secure transmission of the resource through the cryptographic transmission system.

The cryptographic transmission system may include a network of validators (also referred to as “validation units”) that each store users' UTM balances. The network of validation units may validate transmissions. When a transmission is validated by the network of validation units (e.g., when a threshold number of validation units have determined that the transmission is valid or when the network of validation units has reached a consensus that the transmission is valid), the transmission may be executed in the cryptographic transmission system. Execution of the transmission may involve the network of validation units updating their respective memories to reflect the transmission of an amount of a UTM from the user to the recipient(s).

The inventors have recognized that conventional cryptographic transmission systems that utilize a unified transmission medium cannot be used to transmit multiple different resources. Firstly, conventional systems rely on a cryptocurrency in which transmission fees (also referred to as “gas fees”) are paid. Conventional systems typically do not include multiple resource transmission capabilities because having resources in addition to the native cryptocurrency of the systems would detract from use of the cryptocurrency. Conventional systems that do have multiple resource transmissions utilize multiple separate chains that operate independently of one another.

Accordingly, described herein are embodiments of a cryptographic transmission system configured to securely transmit multiple different resources that may belong to users of the system. The cryptographic transmission system may use the UTM to transmit different types of resources. The network of validation units may store, for each of multiple users of the system, multiple UTM balances where each UTM balance represents an amount of a particular resource belonging to the user. When a user requests a transmission of an amount of a resource to recipient(s), the validation units may use the UTM balance representing the amount of the resource belonging to the user to validate the transmission (e.g., by verifying that the user has a sufficient amount of the resource to complete the transmission). Accordingly, the cryptographic transmission system may provide a central system through which users can transmit multiple different resources using cryptography to secure the transmissions. The specific resource transmitted may also be used for distribution of transmission fees associated with a transmission.

The inventors have further recognized that conventional broadcast based transmission systems are limited to a fixed set of validation units that can be used to validate transmissions. Embodiments described herein provide a broadcast based cryptographic transmission system that allows for updating the validation units. The techniques for updating the validation units do not affect finality of transmissions. Some embodiments further include a checkpoint system that allows the cryptographic transmission system to consolidate a set of past transmissions into a checkpoint. The data records for the set of past transmissions may be deleted from memory of the validation units and represented by a checkpoint. Accordingly, the checkpoint system may reduce the amount of memory used by validation units to store a record of transmissions completed by the cryptographic transmission system.

Some embodiments of cryptographic transmission systems may be used as a payment management system. In such embodiments, payments may be implemented as transmissions of a transmission medium (e.g., tokens) from one user to another. It should be appreciated that a payment system is an illustrative application of the cryptographic transmission system described herein to illustrate aspects of the cryptographic system and associated techniques. Embodiments of the cryptographic transmission system described herein are not limited to such an application and may be used for other applications.

Referring now to the drawings that depict different embodiments consistent with the present invention, wherever possible, the same reference numbers will be used throughout the drawings and the following description to refer to the same or like parts. The payment management system 100 provides a broadcast based payment system. The payment management system 100 utilizes an account model that allows for redistributing transactions fees, recovery of locked accounts, governance certificates that determine the set of validators and govern protocol parameters like transaction fees, and the creation of checkpoints throughout the transaction process to expediate payment of transaction fees. By the use of an appropriate broadcast scheme such as a signed echo broadcast or any other appropriate broadcast, valid transactions are final as soon as the broadcast is finished, guaranteeing low latency. By the use of governance certificates, which include a checkpoint, validators (also referred to herein as “validation units”) can be replaced throughout the transaction process, and transaction fees can be paid out upon the completion of the checkpoint. In addition, because each checkpoint consolidates all previously executed transactions, all transactions prior to the checkpoint can be discarded from memory, reducing the memory requirement.

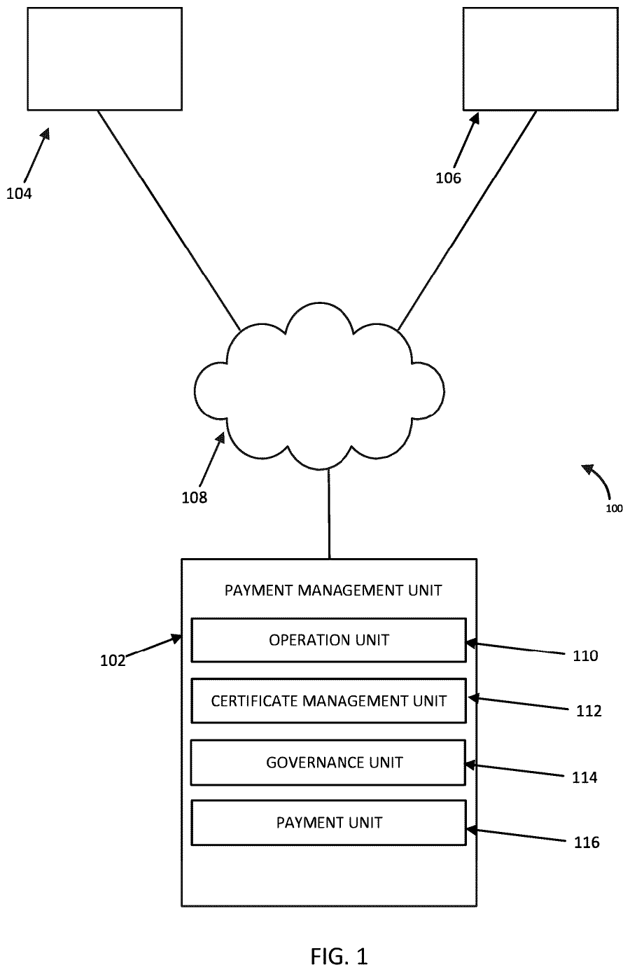

FIG. 1 depicts one embodiment of a payment management system 100 consistent with the present invention. The payment management system 100 includes a payment management unit 102, a communication device 1 104, a communication device 2 106 each communicatively connected via a network 108. The payment management unit 102 further includes an operation unit 110, a certificate management unit 112, a governance unit 114 and a payment unit 116.

The operation unit 110 and certificate management unit 112 may be embodied by one or more servers. Alternatively, each of the governance unit 114 and payment unit 116 may be implemented using any combination of hardware and software, whether as incorporated in a single device or as a functionally distributed across multiple platforms and devices.

In one embodiment, the network 108 is a cellular network, a TCP/IP network, or any other suitable network topology. In another embodiment, the row identification device may be servers, workstations, network appliances or any other suitable data storage devices. In another embodiment, the communication devices 104 and 106 may be any combination of cellular phones, telephones, personal data assistants, or any other suitable communication devices. In one embodiment, the network 108 may be any private or public communication network known to one skilled in the art such as a local area network (“LAN”), wide area network (“WAN”), peer-to-peer network, cellular network, or any suitable network, using standard communication protocols. The network 108 may include hardwired as well as wireless branches.

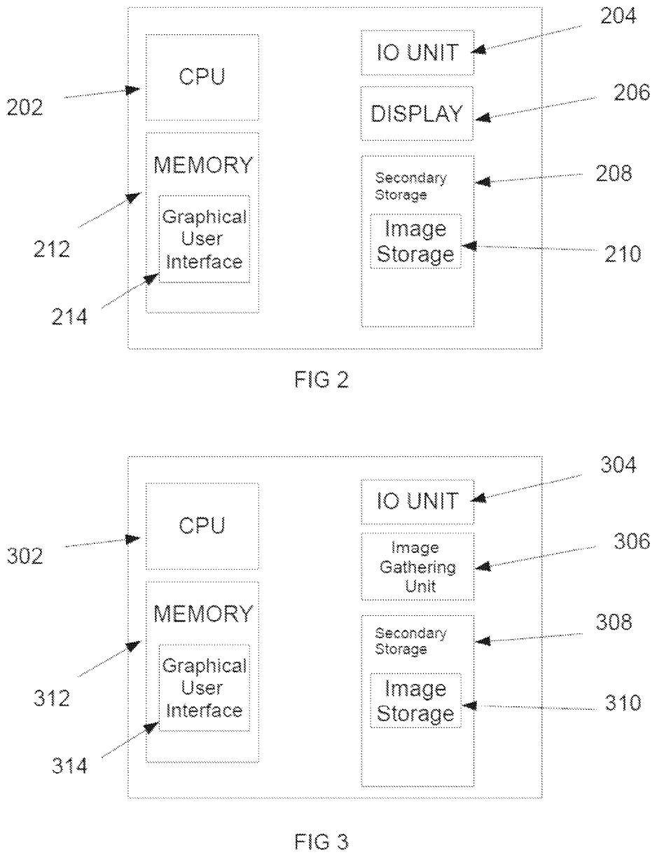

FIG. 2 depicts one embodiment of a payment management unit 102. The payment management unit 102 includes a network I/O device 204, a processor 202, a display 206 and a secondary storage 208 running image storage unit 210 and a memory 212 running a graphical user interface 214. In one embodiment, the processor 202 may be a central processing unit (“CPU”), an application specific integrated circuit (“ASIC”), a microprocessor or any other suitable processing device. The memory 212 may include a hard disk, random access memory, cache, removable media drive, mass storage or configuration suitable as storage for data, instructions, and information. In one embodiment, the memory 208 and processor 202 may be integrated. The memory may use any type of volatile or non-volatile storage techniques and mediums. The network I/O line 204 device may be a network interface card, a cellular interface card, a plain old telephone service (“POTS”) interface card, an ASCII interface card, or any other suitable network interface device. The governance unit 114 may be a compiled program running on a server, a process running on a microprocessor or any other suitable port control software.

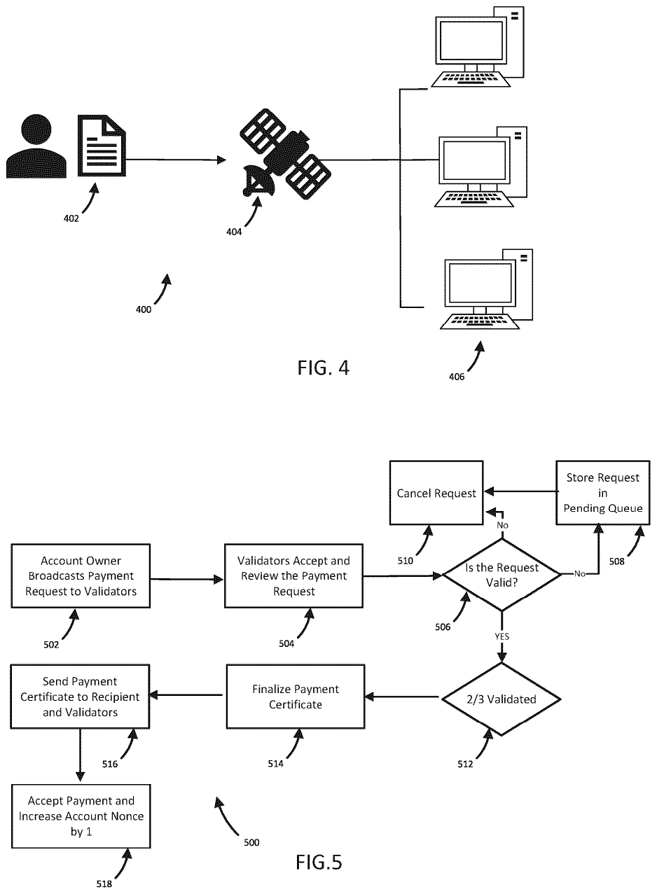

FIG. 3 depicts one embodiment of a communication device 104/106 consistent with the present invention. The communication device 104/1106 includes a processor 302, a network I/O Unit 304, an image capture unit 306, a secondary storage unit 308 including an image storage device 310, and memory 312 running a graphical user interface 314. In one embodiment, the processor 302 may be a central processing unit (“CPU”), an application specific integrated circuit (“ASIC”), a microprocessor or any other suitable processing device. The memory 312 may include a hard disk, random access memory, cache, removable media drive, mass storage or configuration suitable as storage for data, instructions, and information. In one embodiment, the memory 312 and processor 302 may be integrated. The memory may use any type of volatile or non-volatile storage techniques and mediums. The network I/O device 304 may be a network interface card, a plain old telephone service (“POTS”) interface card, an ASCII interface card, or any other suitable network interface device.

In one embodiment, the network 108 may be any private or public communication network known to one skilled in the art such as a Local Area Network (“LAN”), Wide Area Network (“WAN”), Peer-to-Peer Network, Cellular network, or any suitable network, using standard communication protocols. The network 108 may include hardwired as well as wireless branches.

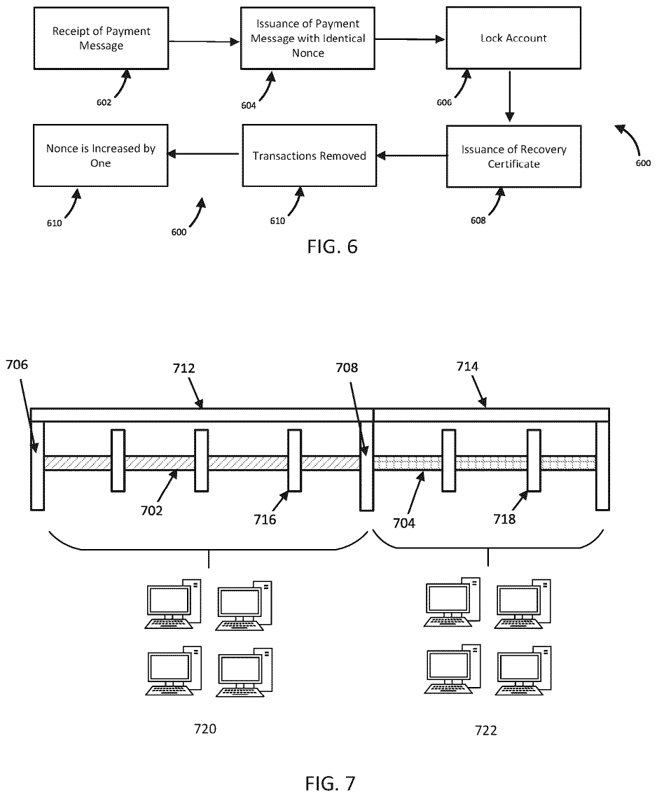

FIG. 4 depicts a schematic representation of the broadcast system 400 for the payment management system 100. An account owner 402 connects to a network 404 and sends out a payment message to a group of validators 406. The payment message is a message that includes the amount to pay, the addresses of the recipients of the funds and identifying information including a nonce associated with the account and a cryptographic signature by the account owner 402. After each validator 406 receives the payment request, the validators review the information in the request and confirm the information is correct. Once two thirds of the validators 406 verify the payment request, signatures of the validators 406 are collected and a payment certificate is sent to the account owner and the recipients of the payment. In one embodiment, the nonce is replaced with the checkpoint identification and/or the epoch identification. Consistent with this embodiment, signed transactions are only valid within one epoch and checkpoint.

In one embodiment, a third party can take the place of the account owner 402 in the process. The third party can transmit a payment message to the account owner 402 and to the validators 406. The third party retains a copy of the payment message and payment certificate after the transaction is complete. The third party, account owner and validators can request notifications of events that occur during the transaction by transmitting a subscribe message that specifies the types of events for notifications and the role of the party requesting notifications. In one embodiment, the roles include account owner, a relayer who is a third party that sends and receives messages for an account owner, a mirror that receives and stores messages related to the account, and a wallet service that can be implemented by a payment application. In another embodiment, a user account is replaced with an Unspent Transaction Output (“UTXO”). Transactions consume one or more UTXOs and send the funds represented by the UTXO to one or more new addresses, thereby creating new UTXOs. Checkpoints can agree on the current state of UTXOs, allowing for the discard of the history, and epoch transitions do not require further adaptation. Transaction fees can be charged by ensuring that the sum of UTXOs is less than the consumed UTXOs and distributed in a checkpoint by creating UTXOs without inputs. UTXOs may also be created with stealth addresses, where only recipients or parties having each party's scanning private keys, have the ability to verify the owner account of a UTXO, thereby providing transaction privacy. Other alternatives for providing privacy include, but are not limited to, signing zero knowledge computation certificates instead of transactions, masking even the existence of a balance. Such privacy-enhancing features may also be combined with the ability to force the operator to reveal balances or transactions by using threshold signatures.

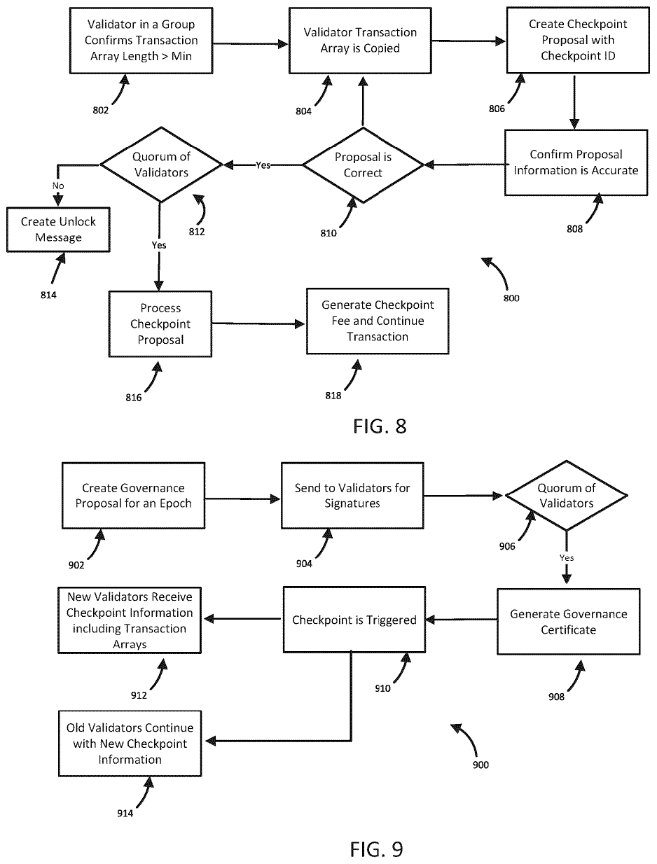

FIG. 5 depicts a schematic representation of a system of processing a payment request 500. In step 502, an account owner issues a payment message to a payment network. The payment message includes the sender's identification, recipients' identification, the amount sent to each recipient, a nonce for the account, and a signature. The payment message is broadcast to all validators on the network. In step 504, validators accept and review the payment request. In reviewing the payment request, each validator verifies the format of the payment message, confirms the nonce is one larger than the last nonce sent from the account, and the account has sufficient funds to pay the amount and any transaction fees. In step 506, each validator determines the validity of the request. The validators make each judgment independently and do not communicate with the other validators. If a request is determined by a validator to have an error that can be corrected, such as a too low balance by the sender, the validator stores the request in a pending queue in step 508. If the request becomes invalid, for example by a different transaction by the same account being finalized, or if the request contains an irrecoverable error, for example a missing signature, the payment request is cancelled in step 510.

In step 512, if the request is determined to be valid by two thirds of the validators reviewing the payment request, the transaction is allowed to move forward. In step 514, a payment certificate is finalized. In finalizing the payment certificate, signatures of at least ⅔ of the validators are included in the payment certificate. The payment certificate can be in any format where at least ⅔ of the validator's signatures are aggregated. The aggregation of signatures may happen using identifiable aggregation, where the identities of the validators whose signature are contained in the aggregate signature can be recovered, and unidentifiable aggregation, where only the presence of a sufficient quantity of signatures is proven. In step 516, the payment certificate is sent to the account owner, any third parties such as relayers, the recipients and the validators. In step 518, funds are transferred to the recipients and the nonce associated with the account is increased by one.

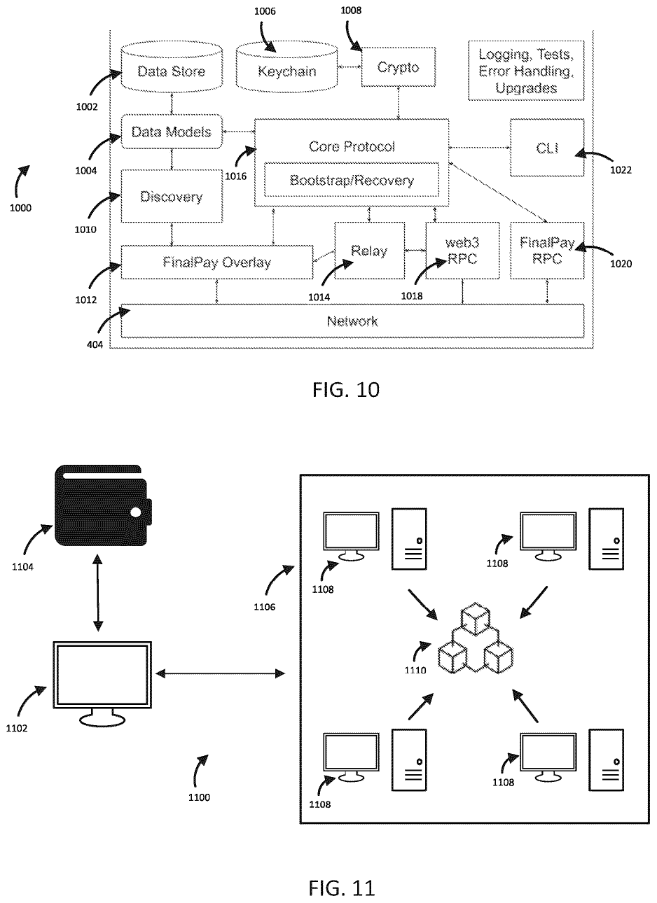

FIG. 6 depicts the schematic representation of a recovery process 600. In step 602, a payment message is transmitted with a nonce to a plurality of at least ⅓ of the validators. In step 604, a second payment message is transmitted with an identical nonce but differing in other fields such as the amount or the recipient to a different plurality of at least ⅓ of the total validators. Because the two payment messages have identical nonces and have been signed by at least ⅓ of the validators each, a two thirds majority of validators cannot be reached. In step 606, the account sending the payment messages with the identical nonces is locked. In step 608, a recovery certificate is sent to the validators. The recovery certificate contains an array of messages with the same nonce along with the signatures for these messages proving that a ⅔ majority for any transaction for this account with this nonce is impossible. A validator receives and validates a recovery message. In step 610, each validator removes the payment messages with the identical nonces. In step 612, the nonce for the account is increased by one any applicable fees are deducted from the account to unlock the account and allow for new transactions.

If an account owner wants to cancel a payment message, the account owner can send a cancellation message to the validators. Upon receipt of the cancellation message, each validator verifies the format of the cancellation message. Once two thirds of the validators have signed the cancellation message, a cancellation certificate is issued, and the payment is cancelled. Cancellation messages can be included in a recovery message to confirm an account will be unlocked. In one embodiment, an account owner may dispute a payment. Consistent with this embodiment, final payment will not be made to any account until a predetermined condition, such as an elapsed time, has occurred.

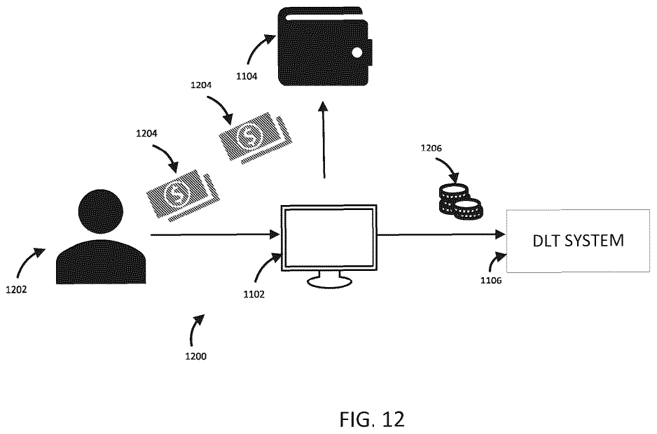

FIG. 7 is a schematic representation of a payment transaction. The validator's signatures of each transaction include epochs 702 and 704 and a checkpoints 716 and 718 which each represent a distinct time period. Each epoch 702 and 704 is initiated by an epoch transition 706 and 708 that is connected to a governance 712 and 714 for the specific epoch. A governance 712 and 714 represents the rules of the transaction including providing a list of all validators 720 and 722, updating fee parameters, updating a list of banned accounts, and software updates. The governance for each epoch 702 and 704 is transmitted to all parties in a governance certificate 712 and 714. A new epoch 702 and 704 is created for each governance certificate 712 and 714 that is issued. In one embodiment, the information related to epochs and checkpoints is included in the payment message signed by the account. In another embodiment, checkpoints 716 and 718 are only created together with an epoch 702 and 704 and only the epoch information is included in the checkpoint 716 and 718 information.

During an epoch, checkpoints 716 and 718 are created where validators confirm the transactions that have happened up to the point where the checkpoint 716 and 718 occurs in the epoch 702 and 704. In one embodiment, a checkpoint 716 and 718 is issued in the same epoch 702 and 704 without a change in the governance 712 and 714. A checkpoint allows validators to verify the current balance of each account by aggregating all transactions, allowing for the storage of only the balances for each account and to discard the transactions. A checkpoint 716 and 718 that changes protocol parameters or adds or changes validators 722 is an epoch transition 706 and 708, triggering a new epoch 704 with a new governance certificate 714. In one embodiment, the epoch transitions 706 and 708 and the checkpoints 716 and 718 are merged together into a single operation.

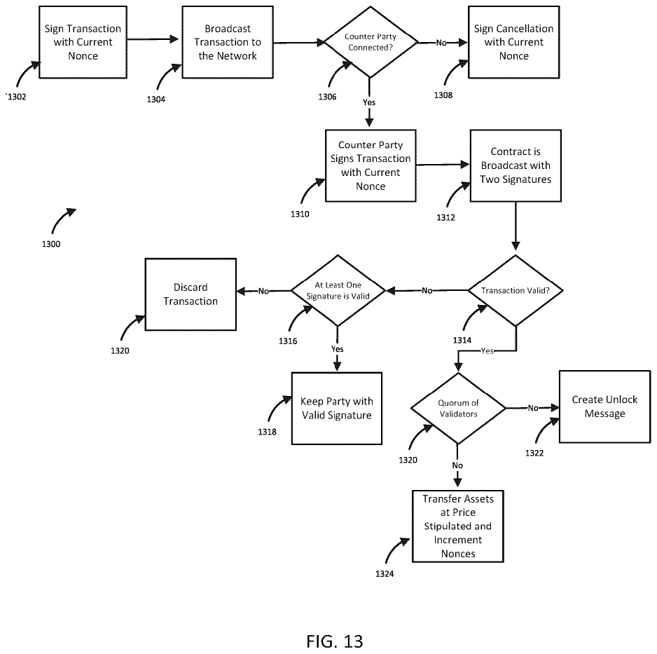

FIG. 8 depicts the schematic representation of a checkpoint creation process. In step 802, a validator, or any node, associated with a transaction confirms the transaction array length is greater than a minimum value. In one embodiment, the checkpoint 716 and 718 creation are triggered by a different event such as a request by a validator or an operator. In another embodiment, a checkpoint 716 and 718 is triggered after a predetermined amount of time has elapsed. In step 804, the validator creating the checkpoint makes a copy of the validator's transaction array. In one embodiment, the copy of the transaction array may be a simple array. In another embodiment, the copy of the transaction array may use an efficient data structure such as a Merkle tree. In step 806, the validator creates a checkpoint proposal that includes the checkpoint identifier, a signature and the transaction array. The transaction array includes a listing of all transactions the validator has identified a certificate associated with the transaction. After creating the checkpoint proposal, the validator starts signing certificates with the checkpoint identifier for the next checkpoint. The validator then sends the checkpoint proposal to the other validators. In step 808, each validator confirms the information in the checkpoint proposal is correct by confirming the conditions for creating a checkpoint are met, each transaction includes correct certificates with checkpoint identifiers up to the last identifier and the transactions each increment the account nonce by one. In step 810, each validator confirms the checkpoint proposal is correct. If a validator receiving a checkpoint proposal has witnessed more transaction certificates than what is included in a checkpoint proposal received by the validator, the validator creates a new transaction array 804 and send out a new checkpoint proposal 806 that includes an updated transaction array including the previously missing transactions. In one embodiment, the validity of the checkpoint proposal is confirmed using practical Byzantine Fault Tolerance (“BFT”). In another embodiment, the validity of the certificate proposal is confirmed using exponential information gathering, Tendermint, Narwhal/Bullshark, and generally all BFT consensus algorithms where authenticated nodes may be assumed in BFT proofs. In step 812, a quorum of ⅔ of validators confirms the checkpoint proposal is correct. In step 814, if different validators have confirmed different checkpoint proposals such that no proposal can reach ⅔ confirmations, an unlock message is created and sent out in step 814. The unlock message contains proof that a quorum is not possible along with a new checkpoint proposal.

In step 816, each validator processes the checkpoint proposal. After the proposal is processed, each validator hashes the state of all accounts and signs the checkpoint hash. In another embodiment, validators sign the hash of the transaction array. Each validator sends the checkpoint hash out over the network. Moving forward, validators sign any new certificates with the new checkpoint identifier. In step 818, the transaction fees of all transactions included in the checkpoint are calculated and paid to all validators participating in the transaction and the transaction continues. In another embodiment of the checkpoint creation process, validators use a consensus to agree on the transactions in the checkpoint.

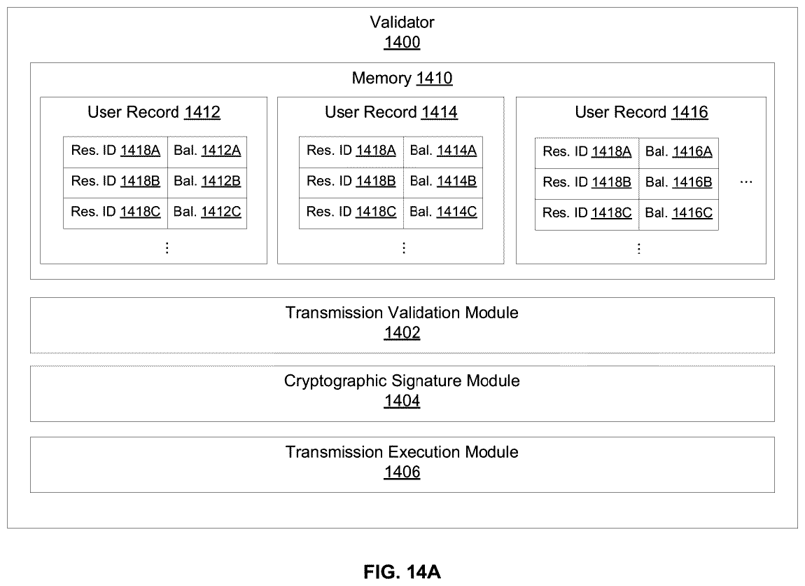

FIG. 9 depicts a schematic representation of a process for creating a governance certificate. In step 902, a governance proposal is created. In step 904, the governance proposal is sent to all validators and each validator signs the proposal. In step 906, a quorum of at least ⅔ of the validators for the current epoch sign the proposal. In step 908, once a quorum of signatures is reached, a governance certificate is created. In one embodiment, a governance certificate is created by a central operator. In step 910, the generation of a governance certificate triggers the creation of a new checkpoint. The new checkpoint ends the current epoch and creates a new epoch controlled by the new governance certificate. The new governance certificate may remove validators, add validators, or exchange validators and set protocol parameters for the new epoch. In step 912, new validators receive checkpoint information including a full list of certificates for transactions associated with the previous epoch. In step 914, existing validators receive the new checkpoint identifier and continue signing requests. Moving forward, each validator uses the new epoch identifier.

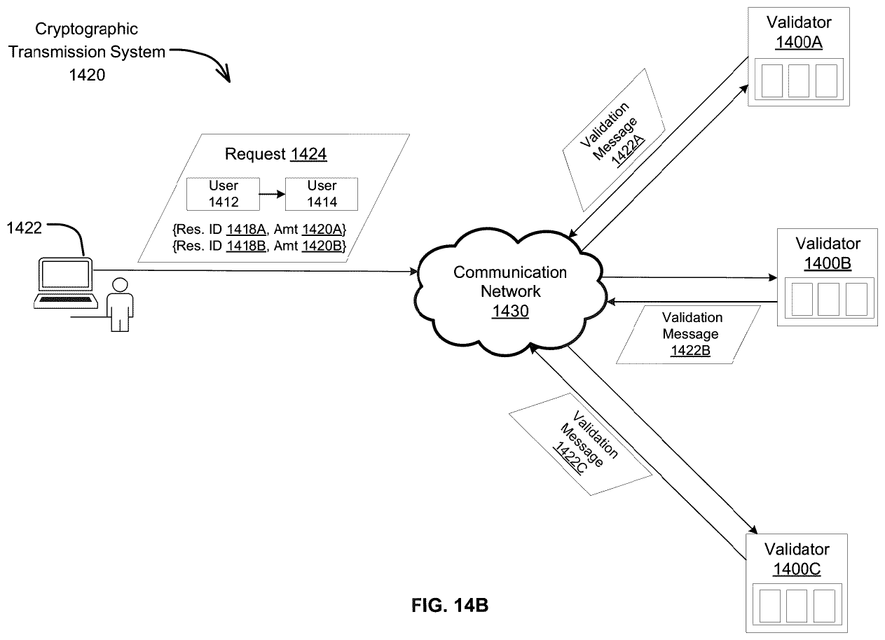

FIG. 10 is a schematic representation of a payment system 1000. The payment system 1000 includes a data store 1002 that stores all relevant data including nonces, account information including balances and other payment process data. A data model 1004 is connected to the data store 1002. The data model 1004 allows querying and modifying the protocol-related system state parameters and other data stored in the data store 1002. On a system level, the data model 1004 gets and sets checkpoint and epoch identifiers, issues checkpoints, manages governance certificates and manages the certificates issued for a transaction. The data model 1004 also manages the accounts of account holders including monitoring account balances and nonces for an account. The data model 1004 also manages the addresses of validators.

The payment system 1000 also includes a keychain 1006 and a crypto module 1008. The keychain 1006 stores private keys used to access the system and the crypto module 1008 provides an interface to sign transactions using the private keys. The crypto module 1008 also manages all signatures including aggregating signatures for certificates that are created. A discovery module 1010 is connected to the data model 1004 and discovers new nodes on the network 404. A FinalPay overlay 1012 is connected to the discovery module 1010 and manages broadcasts made over the network including payment request broadcasts and checkpoint broadcasts. A relay module 1014 is connected to the overlay 1012 which controls validator to validator communications.

The data model 1004, overlay 1012 and relay module 1014 are all connected to a core protocol module 1016. The core protocol module 1016 manages all operations 1016 of the payment system 1000 including managing transactions, initiating checkpoints, managing governance certificates, and updating account information. A Web3 RPC 1018 is connected to the core protocol module to convert Ethereum based messages to common format. A FinalPay RPC 1020 is connected to the core protocol module 1016 and manages messages sent from external sources to the core protocol module 1016. A CLI module 1020. A CLI module 1022 that handles addressing of nodes is connected to the core protocol module 1016.

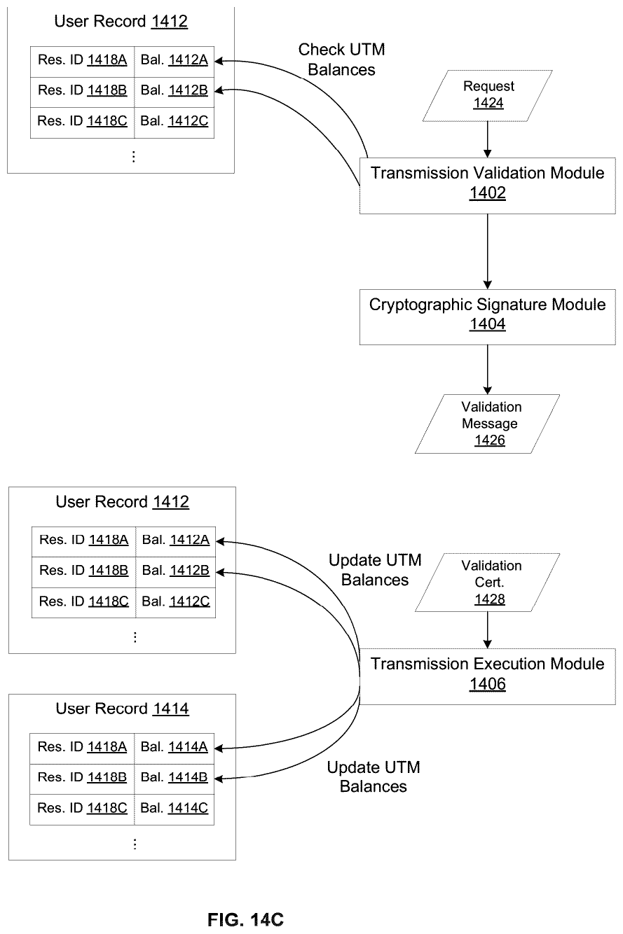

FIG. 11 depicts a schematic representation of a ledger system 1100. The ledger system 1100 includes a safe investment financial account unit 1104 communicatively connected to a trusted operator unit 1102. The safe investment financial account unit 1102 may be any monetary account including, but not limited to, a bank account, investment account or cryptocurrency wallet. The trusted operator unit 1102 is communicatively coupled to a distributed ledger technology (“DLT”) system 1106. The DLT system 1106 consists of validator units 1108 that each communicate under the rules of a DLT protocol 1100. In one embodiment, the DLT protocol 1110 is a level one transaction protocol. The DLT protocol 1110 ensures eventual consistency of the ledger records under Byzantine Fault Tolerance using a consensus mechanism, such as deterministic security guarantees using Ethereum or Solana blockchain, or a broadcast mechanism. The DLT protocol 1110 may also incorporate sybil protection mechanism such as proof-of-state or proof-of-authority permission.

The validator units 1108 replicates a ledger of balances for all accounts. The ledger system has a data structure that stores at least one token balance per account and verifies that adequate funds exist in the safe investment financial account unit 1104 to financially back each newly minted token. The ledger may also store nonces or transaction counters, text including code and the state of a smart contract. The data structure may be a list, a hashmap or another appropriate data structure. Transactions under the ledger system are in the form of messages including a sender, a receiver and an amount. Each message is signed by the sender using public key cryptography or UTXO.

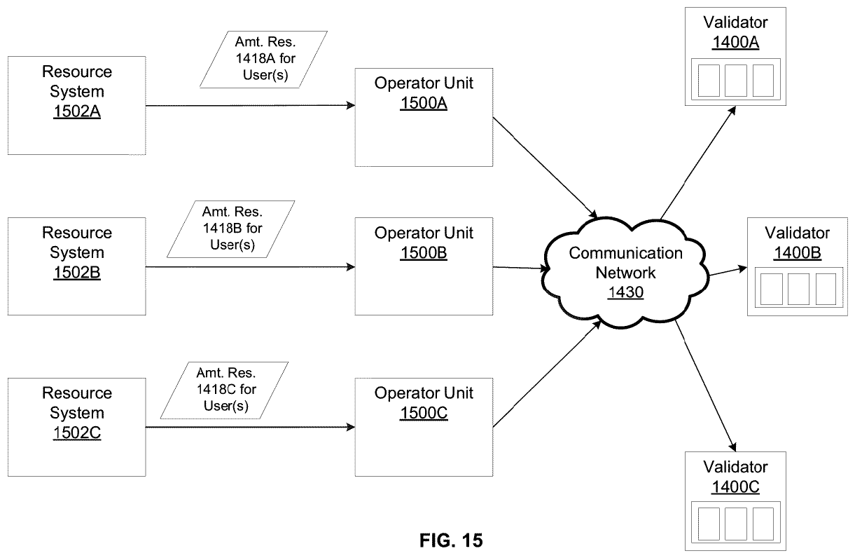

FIG. 12 depicts a schematic representation of a minting process 1200 for a token. The DLT protocol 1100 includes a plurality of tokens with each token corresponding to a unit of fiat currency held in the safe investment financial account unit 1104. A user 1202 sends money 1204, or proof of funds in the safe investment financial account unit 1104, to the operator unit 1102 using traditional means of payment such as a bank transfer. The operator unit 1102 transmits a mint transaction 1206 to the DLT system 1106. The mint transaction 1206 represents a transaction that has one of potentially multiple mint safe investment financial account unit 1104 as the sender. Safe investment financial account unit 1104 is defined in the DLT protocol 1110 and can be changed using the DLT protocol 1110. Changing safe investment financial account unit 1104 requires the signature of the operator unit 1102. Safe investment financial account unit 1104 includes accounts that are defined to have a balance of zero or any arbitrary balance that is not counted towards the total fiat-backed token supply, but may always send arbitrary amounts to other accounts. The operator unit 1202 is trusted to only issue a mint transaction when the safe investment wallet unit 1204 has a corresponding inflow of a fiat currency.

A burn transaction is a transaction with a safe investment financial account unit 1104 as a recipient. Users 1202 can withdraw tokens 1206 from the DLT system 1106 to convert the tokens 1206 back into fiat cash 1204 by providing payment details such as a bank account number to the operator and issue a burn transaction. Once the burn transaction has been finalized by the BFT protocol, the operator unit 1102 issues a fiat payment to the recipient, using the funds invested in the safe asset and the previously minted tokens are removed from the ledger. In one embodiment, where funds were not transferred to the operator unit 1102, the burn process clears the ledger of tokens minted with untransformed funds.

In one embodiment, the DLT protocol 1110 may include a plurality of subsystem including, but not limited to, a payment sub-system, a checkpoint sub-system and a governance sub-system. The payment sub-system control payments, cancellations and recoveries and is controlled by a broadcast mode. The checkpoints sub-system controls memory management including deleting prior transactions and payment of transaction fees. The checkpoints sub-system is controlled by a consensus mode. The governance sub-system controls the updates to protocol parameters and committed management. The governance sub-system is controlled by a consensus mode. The minted tokens may be used to pay transaction fees or any other required settlement.

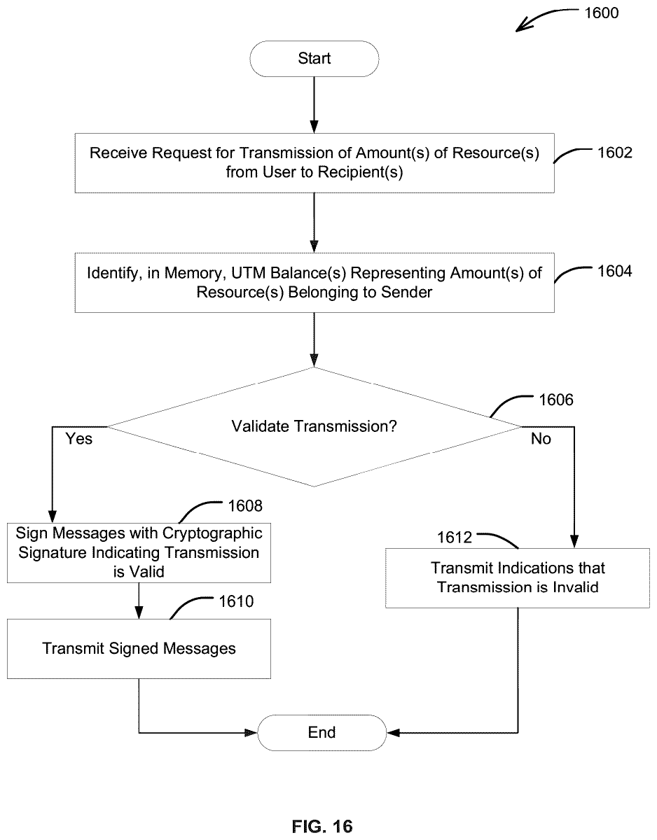

FIG. 13 depicts a schematic representation of a settlement process 1300. In step 1302, a transaction is signed by a first party to a transaction. In step 1304, the signed transaction is broadcast on a network. In step 1306, the first party waits until the second party is connected to the network. In step 1308, if the second party does not connect, the first party signs a cancellation for the transaction. In step 1310, if the second party connects to the network, the second party signs the transaction using the current nonce. In step 1312, the contract signed by both parties is broadcast on the network. In step 1314, a plurality of validators determines if the transaction is valid. In step 1316, the validators check if at least one signature is valid. In step 1320, if no signatures are valid, the transaction is discarded. In step 1318, if one signature is valid, the contract is kept for the valid signing party. In step 1320, if the transaction is valid, the validator confirms if a quorum of validators has validated the transaction. In step 1322, if a quorum has not validated the transaction, an unlock code is generated and the transaction is locked. In step 1324, if the transaction is validated by a quorum, assets are transferred between the parties at a predetermined price and each party's nonce is incremented.

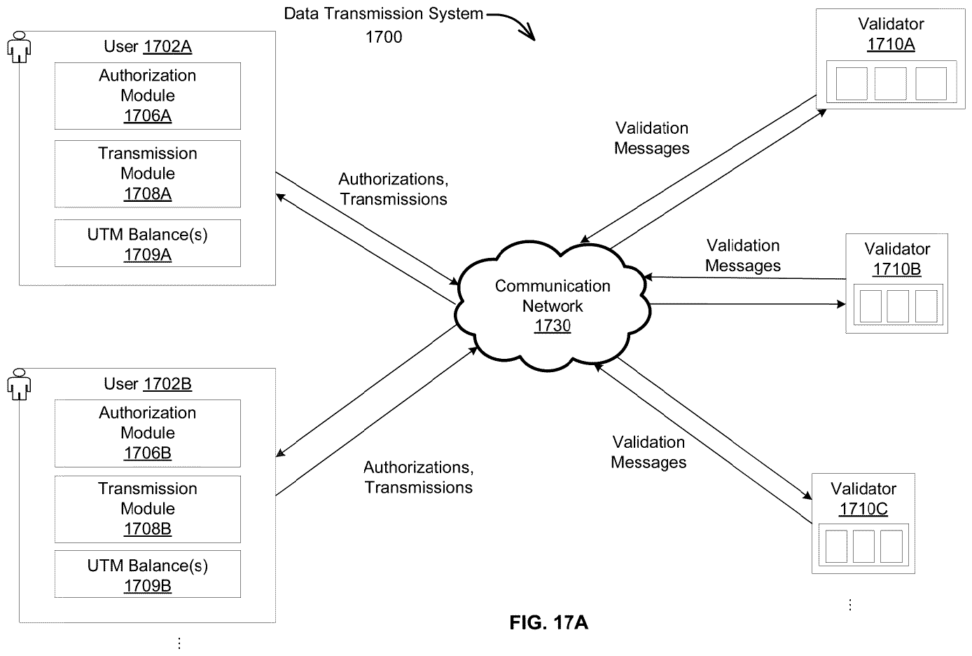

FIG. 14A depicts an example validator (also referred to herein as a “validation unit”) 1400 of a cryptographic transmission system for transmission of multiple different resources, according to some embodiments of the technology described herein. As shown in FIG. 14A, the validator 1400 includes a transmission validation module 1402, a cryptographic signature module 1404, and memory 1410 storing UTM balances for users of the cryptographic transmission system.

In the example of FIG. 14A, the memory 1410 includes a set of user records 1412, 1414, 1416. The memory 1410 may store records for users in addition to the user records 1412, 1414, 1416 depicted in FIG. 14A. For user record 1412, the memory 1410 stores a set of identifications for different resources (“resource identifiers”) 1418A, 1418B, 1418C. The memory 1410 stores UTM balances 1412A, 1412B, 1412C, where each UTM balance represents an amount of one of the resources belonging to a respective user associated with user record 1412. The memory 1412 stores each of the UTM balances 1412A, 1412B, 1412C in association with a corresponding identifier indicating the resource represented by the UTM balance. UTM balance 1412A is stored in association with resource identifier 1418A, UTM balance 1412B is stored in association with resource identifier 1418B, and UTM balance 1412C is stored in association with resource identifier 1418C.

For user record 1414, the memory 1410 stores the set of resource identifiers 1418A, 1418B, 1418C and respective UTM balances 1414A, 1414B, 1414C. Each of the UTM balances 1414A, 1414B, 1414C represents an amount of one of the resources indicated by the resource identifiers 1418A, 1418B, 1418C belonging to the respective user associated with the user record 1414. Likewise, for user record 1416, the memory 1410 stores the set of resource identifiers 1418A, 1418B, 1418C and respective UTM balances 1416A, 1416B, 1416C. Each of the UTM balances 1416A, 1416B, 1416C represents an amount of one of the resources indicated by the resource identifiers 1418A, 1418B, 1418C belonging to the respective user associated with the user record 1416.

The UTM balances stored in the memory 1410 may be balances of any suitable UTM. In some embodiments, the UTM balances may each be a number of coins. The number of coins may represent an amount of a particular resource belonging to a user. Coins may be issued to a particular UTM balance of a user based on an indication of an among of a corresponding resource represented by the UTM balance. For example, UTM balance 1412A may be a number of coins representing an amount of a first currency belonging to a user associated with user record 1412, UTM balance 1412B may be a number of coins representing an amount of a second currency belonging to the user, and UTM balance 1412C may be a number of coins representing an amount of a third currency belonging to the user. UTM balance 1414A may be a number of coins representing an amount of the first currency belonging to a user associated with user record 1414, UTM balance 1414B may be a number of coins representing an amount of the second currency belonging to the user, and UTM balance 1414C may be a number of coins representing an amount of the third currency belonging to the user. UTM balance 1416A may be a number of coins representing an amount of the first currency belonging to a user associated with user record 1416, UTM balance 1416B may be a number of coins representing an amount of the second currency belonging to the user, and UTM balance 1416C may be a number of coins representing an amount of the third currency belonging to the user. As another example, a UTM balance may be a number of coins indicating an amount of a commodity belonging to a user. As another example, a UTM balance may be a number of coins indicating an amount of a financial instrument belonging to a user.

The resources identified by the resource identifiers 1414A, 1414B, 1414C may indicate any suitable resource. In some embodiments, the resource may be any transferrable asset belonging to the user. For example, a resource identifier may indicate a particular currency (e.g., United States Dollar, Euro, Japanese Yen, Pound Sterling, Canadian Dollar, Australian Dollar, Indian Rupee, or another currency). A UTM balance associated with the resource identifier stored in a user record may represent an amount of the currency belonging to a user associated with the user record. As another example, a resource identifier may indicate a commodity (e.g., gold, silver, copper, aluminum, crude oil, natural gas, coal, electricity, wheat, barley, coffee, rice, beef, beans, cotton, sugar, cocoa, or another commodity). A corresponding UTM balance in a user record may represent an amount of the currency belonging to a user associated with the user record. As another example, a resource identifier may indicate a financial instrument (e.g., stock, bond, cryptocurrency, mutual fund, derivative, or another financial instrument). A corresponding UTM balance in a user record may represent an amount of the financial instrument belonging to a user associated with the user record. In some embodiments, different UTM balances may correspond to different types of assets. For example, one UTM balance may represent an amount of a currency belonging to a user while another UTM balance may represent an amount of a commodity belonging to the user.

In some embodiments, the memory 1410 may store the user records 1412, 1414, 1416 as data structures. The memory 1410 may use any suitable data structure to store a user record. For example, the memory 1410 may store the user records 1412, 1414, 1416 as matrices, arrays, linked lists, trees, or another suitable data structure. In some embodiments, the memory 1410 may organize the user records 1412, 1414, 1416 based on an index. The validator 1400 may be configured to search for a user record (e.g., to validate a transmission by a particular user associated with the user record) using the index.

The memory 1410 may comprise storage hardware storing the user records 1412, 1414, 1416. The storage hardware may include one or more hard drives (e.g., hard disk drives (HDD) and/or solid-state drives (SSD)). In some embodiments, the memory 1410 may be part of network attached storage (NAS). In some embodiments, the memory 1410 may be part of a storage area network (SAN). In some embodiments, the memory 1410 may comprise cloud storage in which the user records 1412, 1414, 1416 are stored in one or more servers (e.g., in one or more data centers). The memory 1410 may be accessed by the validator 1400 through a communication network (e.g., the Internet). In some embodiments, the memory 1410 may be a local hard drive of the validator 1400.

As shown in FIG. 14A, the validator 1400 includes a transmission validation module 1402, a cryptographic signature module 1404, and a transmission execution module 1406.

In some embodiments, the transmission validation module 1402 may be configured to validate transmissions of the UTM requested in a cryptographic transmission system (e.g., indicated by messages transmitted to the validator 1400). The transmission validation module 1402 may be configured to validate a given transmission using UTM balances stored in a user record of a user that requested the transmission. The transmission validation module 1402 may be configured to validate a requested transmission using the UTM balances by: (1) identifying UTM balance(s) of the user representing amount(s) of respective resource(s) that are to be transmitted in the transmission, and (2) determine whether the UTM balance(s) are sufficient to complete the transmission. For example, for a transmission of United States Dollars from a user to one or more recipients, the transmission validation module 1402 may determine whether a user's UTM balance representing an amount of United States Dollars belonging to the user is sufficient to transmit a requested amount. As another example, for a transmission of an amount of a commodity to one or more recipients, the transmission validation module 1402 may determine whether a user's UTM balance representing an amount of the commodity belonging to the user is sufficient to transmit a requested amount of the transmission.

In some embodiments, the cryptographic signature module 1404 may be configured to cryptographically sign a message indicating that a requested transmission is valid after the transmission validation module 1402 determines that the requested transmission is valid. The cryptographic signature module 1404 may be configured to generate a signature unique to the validator 1400. For example, the cryptographic signature module 1404 may sign a message using a private key of the validator 1400 (e.g., that can be verified by a corresponding public key). As another example, the cryptographic signature module 1404 may sign a message using a symmetric key (e.g., that can be verified using the same key by another device). In some embodiments, the cryptographic signature module 1404 may be configured to generate a signature by signing a hash using a key of the validator 1400. In some embodiments, the cryptographic signature module 1404 may be configured to attach a generated signature in a set of data (e.g., a message). In some embodiments, the cryptographic signature module 1404 may be configured to generate a signature using a signature algorithm. For example, the cryptographic signature module 1404 may generate a signature using a digital signature algorithm (DSA) or the Ron Rivest, Adi Shamir, and Leonard Adleman (RSA) algorithm.

In some embodiments, the transmission execution module 1406 may be configured to execute transmissions. The transmission execution module 1406 may be configured to execute a transmission by updating UTM balances involved in a transmission. For each of one or more resources being transmitted from a sender to one or more recipients in a transmission, the transmission execution module 1406 may update UTM balances of the sender and the recipient(s) to reflect the transmission of resource(s). For example, for a transmission of an amount of United States Dollars from a sender to a recipient, the transmission execution module 1406 may update a UTM balance of the sender representing an amount of dollars belonging to the sender (e.g., by reducing the UTM balance according to the requested amount of transmission) and a UTM balance of the recipient representing an amount of dollars belonging to the recipient (e.g., by increasing the UTM balance according to the requested amount of transmission).

In some embodiments, the transmission execution module 1406 may be configured to update multiple UTM balances of both a sender and recipient(s) as part of executing a single transmission. The transmission may comprise a transmission of multiple different resources from a sender to recipient(s). Accordingly, the transmission execution module 1406 may be configured to: (1) update UTM balances representing amounts of the resources belonging to the sender, and (2) update UTM balances representing amounts of the resources belonging to the recipient(s).

In some embodiments, the transmission execution module 1406 may be configured to execute a given transmission after the validator 1400 receives an indication that the transmission has been approved. For example, the transmission execution module 1406 may execute the transmission after receiving a validation certificate indicating that a threshold number of validators has validated the transmission. As another example, the transmission execution module 1406 may execute the transmission after receiving an indication that a network of validators has reached a consensus (e.g., using a consensus algorithm) that the transmission is valid.

FIG. 14B depicts an example validation of a transmission indicated by a request 1424 being performed by validators in a cryptographic transmission system 1420, according to some embodiments of the technology described herein. As shown in FIG. 14B, a device 1422 (e.g., a device associated with a sender, a relay device, or another device with permission to request the transmission) transmits the request 1424 through a communication network 1430 to a network of validators that includes validators 1400A, 1400B, 1400C. Each of the validators 1400A, 1400B, 1400C may be as described herein with reference to FIG. 14A.

As shown in FIG. 14B, the request 1424 includes a specification of a sender as a user associated with user record 1412 and a recipient as a user associated with user record 1414. The request 1424 further specifies resource identifiers of resources to be transferred as part of the transmission and amounts of each of the resources. Specifically, the request 1424 specifies an amount 1420A for resource identifier 1418A and an amount 1420B for a resource identifier 1418B. In some embodiments, the request 1424 may include information in addition to the information illustrated in FIG. 14B. For example, the request 1424 may include a nonce of the sender. As another example, the request 1424 may include a nonce of the recipient (e.g., for an atomic settlement). In some embodiments, the request 1424 may be transmitted to the network of validators as one or more messages. For example, the request 1424 may comprise a single message transmitted by a sender. As another example, the request 1424 may comprise multiple messages by multiple parties involved in the transmission (e.g., sender and recipient(s)).

In some embodiments, the cryptographic transmission system 1420 may be configured to use atomic settlement (e.g., as described herein with reference to FIG. 13). Accordingly, both the sender and recipient(s) may be required to sign respective messages with their respective nonces for the transmission to be successfully validated by the network of validators. Thus, the request 1424 may comprise of multiple messages transmitted by all parties involved in a transmission. Validators may check that messages contain the current nonces, and that both parties have a sufficient amount of the resource they want to transmit. The parties may be blocked from performing other transmissions until validation of the transmission is finalized or the transmissions is cancelled. In some embodiments, the transmission may only be valid if certain information included in messages from the parties match. If the transmission is invalid, the parties can cancel the transmission. If there is a conflict, an unlock message may be used to unlock the parties such that they are able to perform other transmissions.

For example, the cryptographic transmission system 1420 may use pure over-the-counter (OTC) atomic settlement in which the parties each sign messages requesting a transmission with the following information: (1) a current nonce of the party, (2) an account to trade with, (3) resource identifier(s) of resource(s) to be transmitted, (4) resource(s) identifier(s) of resource(s) to be received, (5) an amount of the resource(s) to be transmitted, and (6) an amount of the resource(s) to be received. Validators may compare the information included in messages received from the sender and recipient(s) to validate the transmission.

As another example, the cryptographic transmission system 1420 may use an order book style atomic settlement. The parties may sign messages requesting a transmission with the following information: (1) a current nonce of the party, (2) identifier(s) of resource(s) to be transmitted, (3) identifier(s) of resource(s) to be received, (4) a maximum amount of the resource(s) to be transmitted, and (5) a minimum amount of the resource(s) to be received. Validators may compare the information included in messages received from the sender and recipient(s) to validate the transmission.

As another example, the cryptographic transmission system 1420 may use a hybrid atomic settlement approach. One party may send a message including: (1) its current nonce, (2) identifier(s) of resource(s) to transmit, (3) identifier(s) of resource(s) to be received, (4) a maximum amount of the resource(s) to be transmitted, and (5) an exchange rate to be received. Another party may send a message including: (1) its current nonce, (2) a reference to an offer indicating resource(s) to be transmitted and received along with an exchange rate, and (3) an amount of the resource(s) to be transmitted at the exchange rate. In this example, the first message may be signed at one point in time (e.g., by a market maker) and the second message would be generated and finalized instantly based on the first message.

In some embodiments, a transmission may involve multiple resources. An atomicity guarantee may extend to all exchanges in the transmission. Both parties may sign messages containing: (1) their current nonces, (2) accounts to be exchanged with, and (3) a list of exchanges. Each item in the list indicates: an identifier of a resource to be transmitted, an identifier of a resource to be received, an amount of the resource to be transmitted, and an amount of the resource to be received. Validators may determine whether both parties have sufficient amounts of the resources (e.g., based on UTM balances) to validate the transmission. Validators may execute the transmission when they receive an indication of approval (e.g., a validation certificate or an indication that consensus is reached). In some embodiments, more than two parties may agree to a set of transmissions that may involve multiple resources. An atomicity guarantee may extend to all swaps in the transmission. Each of the parties signs a respective message containing: (1) its current nonce, and (2) a list of transmissions where each entry in the list comprises a pair of exchanges. Each item in the list contains the following fields: (1) account transmitting the resource, (2) an identifier of the resource, and (3) an amount of the resource to be transmitted. A multi-party settlement transmission may only be valid if a copy of it is signed by all senders with their current nonces. Validators check that all senders have sufficient amounts of the resources to be transmitted.

In some embodiments, the cryptographic transmission system 1420 may split percentages when combining multiple orders. The percentages may be determined using a number of rules (e.g., proportional to the volume limits in the transmissions or the same for everyone). In many split models (e.g., equal for everyone) there may be rounding issues (e.g., if $100 has be split equally among three parties). In this case the system may have a rule to match one unit more of the smallest denomination supported in the network from one party. Some embodiments may use fair pseudorandom matching to pick the party. For example, matching may be performed by taking the hash of the accounts in the transaction, concatenating the hashes in ascending numerical order, and then picking the account number closest in numerical value to the hash. Ties may be broken using the last bit of the hash (e.g., 0—pick the one, 1—pick the other).

In some embodiments, the cryptographic transmission system 1420 may be configured to keep partially completed transmissions alive. In the orderbook and hybrid atomic settlement embodiments, it makes sense to allow matching only part of the amount that a party would be willing to transmit. In the standard version, that order would then still be considered resolved, so if a party whose transmission was partially completed wants to make more transmissions in the same resource pair at the same price, they would have to sign a new message. The system may be configured to allow keeping a partially completed transmission alive if the party on the other side of the transmission includes a new nonce specific to the transmission of the other party. The message of the second party in the hybrid model would then contain the fields: (1) the current nonce, (2) reference to an offer of a first type to transmit (which specifies a resource to transmit and receive and an exchange rate), (3) a nonce of the referenced offer, and (4) an amount of the resource to transmit at the exchange rate. Validators would check that the nonce of the referenced offer is indeed the latest nonce for that offer, in addition to the other fields. The rest of the transmission processing happens in the same way, and after the transmission is final, the referenced offer remains alive, with the maximum amount reduced by the amount in the transmission.

As shown in FIG. 14B, the validators 1400A, 1400B, 1400C validate the requested transmission. The validators 1400A, 1400B, 1400C may be configured to validate the requested transmission using UTM balances stored in user records (e.g., as described herein with reference to FIG. 14C). When a validator determines that the requested transmission is valid, the validator transmits a validation message to the device 1422. The validation message may include a cryptographic signature of the validator. In the example of FIG. 14B, the validator 1400A transmits validation message 1422A including its signature to the device 1422 through the communication network 1430, the validator 1400B transmits validation message 1422B including its signature to the device 1422 through the communication network 1430, and the validator 1400C transmits validation message 1422C including its signature through the communication network 1430. In some embodiments, the validators 1400A, 1400B, 1400C may be configured to execute the transmission in response to receiving an indication of approval. For example, the validators 1400A, 1400B, 1400C may execute the transmission in response to receiving a validation certificate (e.g., indicating that a threshold number of validators have determined the transmission to be valid or that consensus has been reached by the validators).

FIG. 14C depicts the operation of a validator in validating the requested transmission of FIG. 14B, according to some embodiments of the technology described herein. The transmission indicated by the request 1424 specified an amount of resource identifier 1418A and an amount of resource identifier 1418B to be transmitted from the user associated with user record 1412 to the user associated with user record 1414. As shown in FIG. 14C, the transmission validation module 1402 first checks the UTM balances 1412A, 1412B associated with respective resource identifiers 1418A, 1418B in the user record 1412. The transmission validation module 1402 may be configured to determine whether the UTM balances 1412A, 1412B are sufficiently high to complete the requested transmission. For example, the transmission validation module 1402 may determine if the UTM balances 1412A, 1412B represent amounts of respective resources that is greater than amounts of the resources requested for transmission. As another example, the transmission validation module 1402 may determine if the UTM balances 1412A, 1412B represent amounts of respective resources that is greater than the amounts of the resources requested for transmission by a threshold amount (e.g., to ensure that there is a sufficient balance for distribution of transmission fees to validators and/or other entities).

In some embodiments, the transmission validation module 1402 may be configured to perform other checks in addition to determining whether the balances 1412A, 1412B are sufficient. For example, the transmission validation module 1402 may check nonces provided by one or more parties involved in the transmission. As another example, the transmission validation module 1402 may determine whether the information in messages from different parties aligns (e.g., as described herein with reference to FIG. 14B for atomic settlements).

Once the transmission validation module 1402 determines that the UTM balances 1412A, 1412B are sufficient to complete the transmission, the cryptographic signature module 1404 may sign a validation message 1426 indicating that the requested transmission is valid. In some embodiments, the cryptographic signature module 1404 may be configured to sign the validation message 1426 with a cryptographic signature of the validator 1400. The cryptographic signature module 1404 may be configured to transmit the validation message 1426 to the device 1422 indicating that the validator has determined the requested transmission to be valid.

As shown in FIG. 14C, the transmission execution module 1406 executes the transmission in response to receiving a validation certificate 1428. In some embodiments, the validation certificate 1428 may indicate that a threshold number of validators have determined the requested transmission to be valid. In some embodiments, the validation certificate 1428 may indicate that the validators of the validation network have reached a consensus that the requested transmission is valid (e.g., using a consensus algorithm). As shown in FIG. 14C, the transmission execution module 1406 executes the transmission by: (1) reducing UTM balances 1412A, 1412B corresponding to resource identifiers 1418A, 1418B of the user record 1412 by the amount specified in the request 1424 (i.e., because the user associated with the user record 1412 is the sender in the requested transmission), and (2) increasing the UTM balances 1414A, 1414B corresponding to resource identifiers 1418A, 1418B by the amount specified in the request 1424 (i.e., because the user associated with the user record 1414 is the recipient in the requested transmission). In some embodiments, the transmission execution module 1406 may be configured to unlock the users involved in the transmission such that they may perform transmissions in the cryptographic transmission system 1420.

In some embodiments, the validators 1400A, 1400B, 1400C that validated the requested transmission may receive transmission fees. The validators 1400A, 1400B, 1400C may be configured to receive, from one or more of the parties involved in the transmission, amounts of the UTM representing the resources involved in the transmission. Users associated with the validators 1400A, 1400B, 1400C may have associated user records of UTM balances corresponding to resource identifiers (e.g., a described in the memory 1410 of the validator 1400). The user records may be updated based on the UTM transmissions. For example, UTM balances of the users associated with resource identifier 1418A may be updated to include a percentage of the UTM amount that was transmitted for the corresponding resource, and UTM balances of the users associated with resource identifier 1418B may be updated to include a percentage of the UTM amount that was transmitted for the corresponding resource. Accordingly, validators may be distributed transmission fees in the UTM that was involved in the transmission.

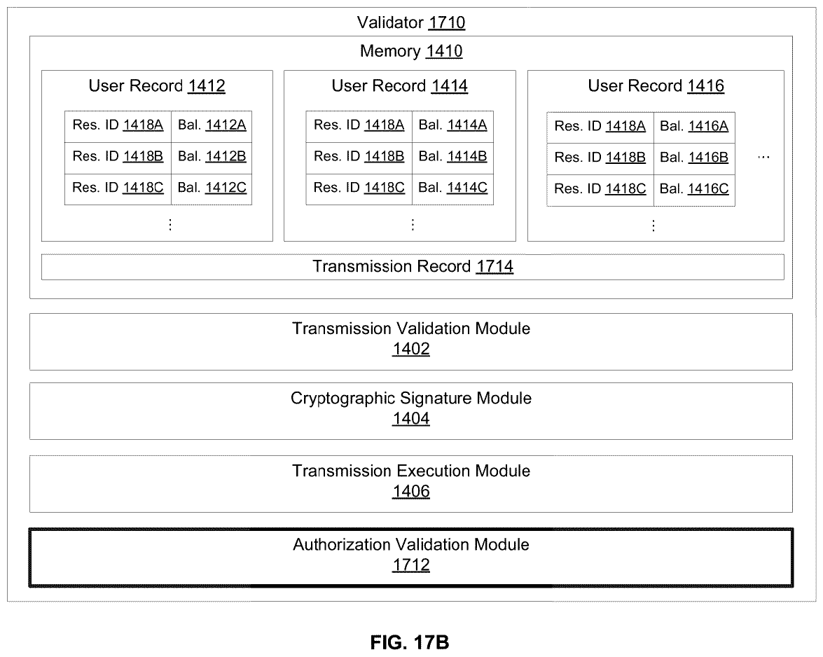

FIG. 15 depicts issuance of amounts of a uniform transmission medium to users of a cryptographic transmission system, according to some embodiments of the technology described herein. As shown in FIG. 15, the cryptographic transmission system includes operator units 1500A, 1500B, 1500C which receive indicates of amounts of respective resources belonging to users and transmit messages to a network of validators to issue amounts of UTM to users (e.g., by updating user records).

In some embodiments, each of the operator units 1500A, 1500B, 1500C may be associated with a particular one of the plurality of resources. For example, operator unit 1500A may be associated with a resource indicated by resource identifier 1418A, operator unit 1500B may be associated with a resource indicated by resource identifier 1418B, and operator 1500C may be associated with a resource indicated by resource identifier 1418C. As shown in FIG. 15, the operator units 1500A, 1500B, 1500C may be configured to communicate with respective resource systems 1502A, 1502B, 1502C. For example, the operator units 1500A, 1500B, 1500C may be configured to communicate with respective resource systems 1502A, 1502B, 1502C through respective application program interfaces (APIs). In some embodiments, an operator unit may be configured to receive, from a respective resource system, amounts of a particular resource belonging to a particular user. For example, an operator unit may receive an indication of an amount of currency belonging to a user from a resource system (e.g., a bank). As another example, an operator unit may receive an indication of an amount of a commodity belonging to a user from a resource system (e.g., a commodity trading platform).

In some embodiments, an operator unit may be configured to communicate with multiple resource systems. Although in the embodiment of the FIG. 15 the system includes multiple operator units, in some embodiments, the system may include a single operator unit that communicates with the resource systems 1502A, 1502B, 1502C.

In some embodiments, an operator unit may be configured to receive an indication of an amount of a respective resource belonging to a user. The operator unit may be configured to determine an amount of the UTM representing the amount of the resource belonging to the user. The operator unit may be configured to transmit a message indicating to issue the determined amount of the UTM to the user. The message may cause the validators to update a UTM balance of the user associated with the resource (e.g., by increasing UTM balance by the UTM amount issued). The validators 1400A, 1400B, 1400C may be configured to receive the message indicating the amount of the UTM to issue to the user for the resource and, in response, update the UTM balance associated with the resource (e.g., by a corresponding resource identifier). For example, the validators may update the UTM balance by increasing the UTM balance by the amount of UTM indicated by the issuance message.

In some embodiments, an operator unit may be configured to determine an amount of UTM to issue to a user by converting an indicated amount of a resource belonging to the user to the amount of UTM. For example, the operator unit may be configured to use conversion rates of amounts of resources to amounts of UTM. The operator unit may use the conversion rates to determine amounts of UTM to issue to different UTM balances in user records. In some embodiments, the conversion rates may be variable over time. In some embodiments, the conversion rates may be static. In some embodiments, an operator unit may be configured to receive, from a device, an indication of an amount of UTM to be removed from a UTM balance of a user of the cryptographic transmission system. The operator unit may be configured to transmit a message to the network of validation units indicating a command to remove the amount of UTM from the UTM balance of the user of the cryptographic transmission system.

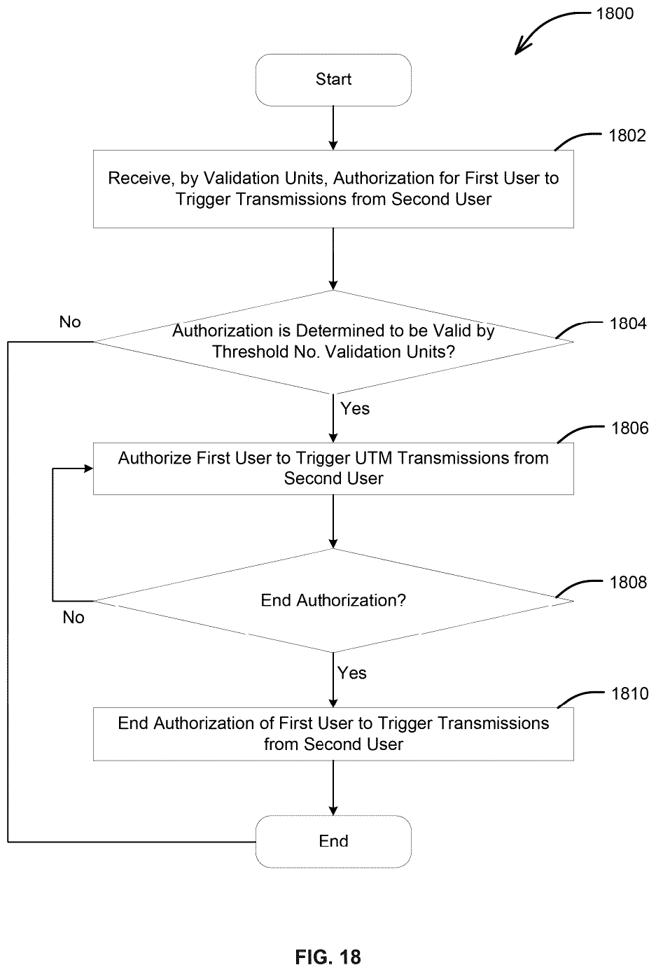

FIG. 16 depicts an example process 1600 for transmitting one or more resources using a cryptographic transmission system, according to some embodiments of the technology described herein. For example, process 1600 may be performed using the cryptographic transmission system 1420 described herein with reference to FIGS. 14A-14C (e.g., with validators configured as described herein with reference to FIG. 14A).

Process 1600 begins at block 1602, where validation units of the cryptographic transmission system (e.g., of a network of validation units) receive a message indicating a request for a transmission of amount(s) of one or more resources from a user (also referred to as the “sender”) to a set of one or more (also referred to as the “set of recipient(s)”). In some embodiments, the validation units may be configured to receive a request comprising a message from the sender. The message may indicate identifier(s) of the resource(s) and the amount(s) of the resource(s) along with a current nonce of the sender. In some embodiments, the system may use atomic settlement in which the validation units are configured to receive messages from the sender and the set of recipient(s) (e.g., as described herein with reference to FIG. 14B). For example, each of the messages may indicate a current nonce of the user, identifier(s) of resource(s) to be transmitted, and amount(s) of resource(s) to be transmitted. Other examples of information that may be included in the messages are described herein with reference to FIG. 14B.

Next, process 1600 proceeds to block 1604, where the validation units identify, in their respective memories, UTM balance(s) representing amount(s) of the resource(s) to be transmitted that belong to the sender. A validation unit may be configured to read a user record from its memory storing UTM balances of the sender, where each UTM balance represents an amount of a particular resource that belongs to the sender. For example, the validation unit may identify a data structure (e.g., a table, matrix, or other data structure) in its memory storing the user record. The validation unit may identify, in the data structure, UTM balance(s) representing amount(s) of the resource(s) to be transmitted that belong to the sender. For example, the validation unit may identify, in the data structure, number(s) of tokens that each represent an amount of one of the resource(s) that belong to the sender.

Next, process 1600 proceeds to block 1606, where the validation units validate the transmission. A validation unit may be configured to validate the transmission using UTM balance(s) identified at block 1604. The validation unit may be configured to determine whether the UTM balance(s) are sufficiently high to transmit the amount(s) of resource(s) specified in the requested transmission to the set of recipient(s). In some embodiments, a validation unit may be configured to perform other validation steps (e.g., as described herein with reference to FIG. 14B). For example, the validation unit may verify nonce(s) included in message(s) received from the sender and/or the set of recipient(s). As another example, the validation unit may verify that information indicated in a message from the sender matches information in message(s) from the set of recipient(s) (e.g., as part of an atomic settlement scheme).

If the validation units determine that the requested transmission is valid at block 1606, then process 1600 proceeds to block 1608 where the validation units sign messages with respective cryptographic signatures indicating that the transmission is valid. A validation unit may be configured to sign a message with a cryptographic signature (e.g., generated using a private key of the validation unit). Next, at block 1610, the validation units transmit signed messages to a device (e.g., that requested the transmission). Although not illustrated in FIG. 16, the validation units may subsequently receive a validation certificate (e.g., if a threshold number of validation units validate the transmission or the validation units reach a consensus that the transmission is valid) and, in response, execute the transmission.

If the validation units determine that the requested transmission is not valid at block 1606 (e.g., because the UTM balance(s) are insufficient, or request message(s) do not include valid information), the process 1600 proceeds to block 1612, where the validation units may transmit indications that the transmission is invalid. For example, a validation unit may transmit a message to a device indicating that the requested transmission is invalid.

### Example Implementations of Some Embodiments

In one example implementation, a cryptographic transmission system may be used as a payment system referred to as FinalPay. In the payment system, transactions are final after a consistent broadcast of a valid transaction. Broadcast-based payment systems offer equivalent security guarantees to consensus based blockchains (Byzantine fault tolerance, BFT), but achieve faster finality and are highly scalable through node-level sharding (recent experiments demonstrate 100 k+ TPS at ~100 ms latency until finality). In some embodiments, the system features an account model that is fully compatible with Ethereum/Metamask, transaction fees that are redistributed to validators, account recovery, checkpointing, committee reconfiguration, and governance. Validators are permissioned and the protocol enforces compliance with banned account regulations. In some embodiments, there is no staking requirement, no slashing, and no proof-of-work. Validators are rewarded proportional to participation but without money creation. The native token is exclusively created through a central mint (e.g., an operator unit) agreed on by validators, and can also be bridged to other chains as an ERC-20 or equivalent token. Some embodiments implement an asynchronous solution for account recovery that does not affect finality or latency. Another limitation of existing broadcast-based payment systems is fixed committees. Some embodiments present a solution for updating the validator set that also allows voting on governance changes and creating checkpoints. The governance and the checkpointing systems do not interfere with the finality of payments. Some embodiments prove the safety and liveness of FinalPay under Byzantine faults.

In some embodiments, FinalPay consists of three sub-systems, a payment system, a checkpointing system and a governance system. The payment system allows users to issue payment transactions, it also provides cancellation and account recovery features that ensure liveness for all accounts. The governance system partitions transactions into epochs, checkpoints further partition the transactions within an epoch. Importantly, the assignment of transactions to epochs and checkpoints happens retro-actively. Epoch transitions and checkpoints do not interrupt the processing of payments and they do not affect their finality. Valid payments are immediately final after completing a consistent broadcast of the transaction. This near-instant finality allows for extremely low latency and gives the system its name. Some embodiments include a governance system to allow making changes such as adding or removing validators or changing fees and other protocol parameters. Epoch transitions necessitate creating a checkpoint, where validators agree on the state of the system up to a certain point. Some embodiments separate out the checkpointing system to allow making checkpoints even when no governance changes are due. This is to support the operation of the system at high loads: experiments have shown that systems using the same broadcast primitives as FastPay can support over 100 k transactions per second (TPS). At such rates, keeping all transactions in memory would quickly become untenable.

Checkpoints allow discarding old transactions from memory, thus ensuring that the system can remain operational at sustained high loads. In some embodiments, both checkpoints and epoch transitions are possible to complete within seconds (not counting the bootstrap time for newly joining nodes), some embodiments checkpoints when certain memory thresholds are met, likely resulting in multiple checkpoints per day, while only making governance changes on an ad-hoc basis at a likely much lower frequency.

Some embodiments implement a version of FinalPay where validators need permission by an operator (sometimes referred to as proof-of-authority) and money creation is controlled by the operator. It may be noted that FinalPay could also be implemented with various other design choices, e.g. a permissionless cryptocurrency using proof-of-stake, or combined with smart contracts.

In some embodiments, examples of roles and actions include:
a. Account owner: send and receive transactions; account owners have three ways to interact with the system: they can either query a pull notification about the current state from a validator (trusted for liveness) and then broadcast a transaction themselves, or they can use one of the following options:
   i. Wallet: a light-weight software client that can send transactions and subscribe to push notifications for selected accounts.
   ii. Mirror or archive mirror: subscribes to all message notifications and keeps track of the full state, either since the last checkpoint (mirror) or since genesis (archive mirror); responds to state queries by any party.
   iii. Relayer: a special service that relays payments on behalf of an account (only needs to be trusted for liveness).
b. (Standard) validator node: checks submitted payment transactions for correctness, signs correct transactions, keeps a log of transactions since the last checkpoint, signs governance proposals, votes in consensus (required for checkpointing).
c. Archive node: a validator node that keeps a log of all transactions since the beginning; running a validator node as an archive is optional and it provides full audibility; it is voluntary and the protocol does not punish validators for running only a standard node.
d. Operator: mints and burns the native token, issues governance proposals for the next epoch.

In some embodiments, example message types include:
a. Payment: send native token funds from the sender to a list of recipients.
b. Cancellation: allows cancelling payments that have not yet reached a quorum (typically because the sender does not have sufficient funds).
c. Recovery: byzantine behavior by the sender can in rare cases lead to the account getting locked, this transaction type allows recovering such accounts.
d. Governance: lays down protocol parameters (including the list of validators) for the next governance epoch; a minor related message type is KeyRotation that validators can send to the operator to ask them to use a new signing key or account address for them in the next epoch.
e. Checkpoint: a snapshot of the current state of each account, including newly distributed transaction fees that are credited to validators' accounts.
f. Subscribe: request to be included in broadcasts for specified message types.
g. Query: request information about any aspect of the state.

In some embodiments, a payment message may have the following example elements:
a. Sender: the sender's address
b. [Recipients]: an array of recipient addresses
c. [Amounts]: an array of unsigned 256-bit integers corresponding to the amounts sent to each recipient (the length of the lists has to match)
d. Nonce: counter of transactions sent by that account
e. Data (optional): allows appending extra information regarding the transaction
f. Signature: a hash of the above data, signed by the sender

In some embodiments, validators who sign the transaction include the following fields:
a. Epoch: the current epoch ID (validators include this in the data they sign-so validators' signatures are always valid for one epoch, while the transaction data above signed by the sender is valid indefinitely).
b. Checkpoint: the current checkpoint ID (validators include separate checkpoint and epoch IDs because governance and checkpointing happen independently).
c. Signature: a hash of the transaction, concatenated with the epoch ID, signed by the validator.

In some embodiments, the presence of the following field makes the message a payment certificate:
a. Signatures: an aggregate representation of a quorum of signatures by the current epoch's validators.

In some embodiments, a governance message has the following example elements:
a. Epoch: the epoch ID for the next governance epoch (epoch IDs always increment by one).
b. [Validators]: an array of public keys, account addresses and IP addresses of the validators for the next governance epoch and a Boolean indicating whether the validator self-declares to be an archive node.
c. Operator: the public key for the operator for the next governance epoch.
d. Mint: the account address for this epoch's mint account.
e. [Banned]: an array of account addresses that are not allowed to effect transactions (this may be replaced by a reference to such a list, e.g., a URL).
f. Parameters governing the protocol (our suggested starting values in parentheses): TxFee ($0.01), CancellationFee ($0.02), RecoveryFee ($0.03), inTxToCheckpoint (expected number of transactions per day) and OperatorFeeShare (20%).
g. Version: a reference to a canonical implementation of the protocol for the next epoch (e.g., a link of a tuple to a git repository, a commit hash and a hash of the repository's content).

In some embodiments, the presence of the following example fields makes the message governance certificate:
a. Signatures: an aggregate representation of signatures of a hash of the above data signed by a sub-quorum of the previous epoch's validators; validators use the private key corresponding to the public key contained in the [Validators] array to sign this message; validators who changed their signing keys from the last epoch include a separate signature of their new key signed with their old key.
b. Signature: a hash of the above data, signed by the last epoch's Operator

Some embodiments may use other messages in addition to or instead of the example messages described herein.

In some embodiments, each validator (standard and archive nodes) V keeps a copy of the current system state in memory, consisting of:
a. Keys: the private keys corresponding to the public key and to the account (validators can use different spending and signing keys) included in the current epoch's governance message for V.
b. [Epochs]: an array of tuple of governance certificates for all epochs from the beginning up to the current, and an integer denoting the amount of yet undistributed transaction fees for transactions that have already been checkpointed with a certificate referring to that epoch (always in the range from 0 to one less than the number of validators in that epoch).
c. Checkpoint: contains a copy of the Accounts state at the last checkpoint (only the Nonce and Balance fields), the ID of the last checkpoint and its hash.
d. Subscriptions: all subscription requests received (that have not expired yet).
e. [Transactions]: an array of transaction (payment, cancellation and recovery) certificates seen by V since the last checkpoint.
f. [Archive] (only for archive nodes): an array of all transaction certificates from genesis up to the last checkpoint
g. Accounts: a mapping from account addresses to the data for each account.

In some embodiments, the state of an account A kept by the validator V may include the following:
a. Key: the public key for the account.
b. Nonce: an unsigned integer representing the number of payment certificates sent by A seen by V.
c. Balance: unsigned integer representing the balance of the account (in $ cents); balances are increased if payments are received or the account is a validator account receiving transaction fee rewards, and decreased through outgoing payments; the balance of the current epoch's mint wallet is always 0 by definition.
d. [Pending] (if applicable): an array of valid payment messages sent by A that have not been signed by V yet and no certificate has yet been seen by V.

In some embodiments, a protocol defines the rules for transitions on the state, e.e., all actions available to the different roles. In some embodiments, a committee or a set of validators or nodes (these terms interchangeably) is always valid for an epoch. Some embodiments make the standard assumption that >⅔ of the validators in any epoch are always correct in adhering to the protocol. Some embodiments index epochs by e, and refer to the validator set for an epoch as Ve and the maximum allowed number of faulty nodes as fe, or f where the context is clear. In some embodiments, any subset of at least 2fe+1 validators for an epoch as a quorum, and any subset of at least fe+1 validators as a sub-quorum. The term certificate may refer to any message that includes signatures by a quorum of validators for the contents of the message. In the context of creating certificates, some embodiments aggregate signatures in general. In practice, one can distinguish between identifiable aggregation, which allows identifying the validators who contributed to a certificate, and anonymous aggregation, which does not. The protocol is valid with both kinds, only assuming that non-interactive aggregation is used. The choice between identifiable and anonymous aggregation has implications for the ability to monitor node participation and for performance. To give some examples, a list is arguably the simplest form of identifiable aggregation, while BLS signatures are standard for anonymous aggregation (and have the advantage of consuming the same space as a single signature).

In some embodiments, an example process for making a payment may be as follows:
a. Sign: a sender initiates a payment by creating and signing a payment message.
b. Broadcast: the sender, or anyone on their behalf, sends the signed payment message to all validators.
c. Countersign: validators who receive a payment message verify that it is valid: it must be correctly formatted and the nonce must be exactly one greater than the last nonce and the account must have a sufficient balance to pay for all amounts sent plus all transaction fees, according to the governance certificate for the current epoch; if the message is valid, and no other transactions with the same nonce by that sender are currently stored as pending, the validator signs the message and together with the current checkpoint ID and epoch ID, and sends it back to the sender; signed transactions and transactions with an insufficient amount or a too high nonce are stored in [Pending]; if nodes see a too high nonce, they query random other nodes to confirm whether they have missed any transactions
d. Finalize: the message is final as soon as the sender, or anyone, sees a quorum of signatures; they aggregate the signatures, creating a payment certificate and send it to all validators
e. Accept: validators accept a payment when they see a certificate; they add it to their Transactions array and record the effects of the payment and the transaction fees in their Accounts; if they had previously stored the message as pending, they remove the pending message

In some embodiments, only the first step-signing the transaction-requires participation by the sender. In some embodiments, anyone who sees that a payment has reached a quorum of signatures (4) knows that its finality is guaranteed, even before validators have accepted it (5). This can be used to reduce latency even further, by sending the certificate to the recipient before it is sent to validators. A payment transaction can have arbitrarily many recipients. Sending payments to multiple recipients guarantees atomicity (all payments are executed simultaneously, if the transaction is correct, or none are executed) and reduces latency (all transactions clear at the same speed as a single one, instead of one after another), but does not reduce transaction fees (the sender pays G.TxFee for each entry in P.Amounts, even if multiple amounts are sent to the same account).

In some embodiments, minting and burning the native token takes the same form as regular payment transactions. Mint transactions are payments where P.Sender==G.Mint and burn transactions are payments where P.Recipients [i]==G.Mint for some i. The processing of mint and burn transaction differs from regular payments in that the balance of the mint wallet is always zero, so burn transactions do not increase it and mint transactions of any amounts are valid despite the balance being zero. In some embodiments, no transaction fees are deducted or distributed to validators for mint and burn transactions.

In some embodiments, one remarkable aspect of the payment system is that it produces a very low number of messages (e.g., validators do not communicate with each other). It makes sense to provide an option for other parties to subscribe to messages about state changes-going beyond the minimal number of required messages enables several services that improve user experience: Relayers take over messaging on behalf of a sender (another remarkable aspect is that once the payment has been signed by the sender, the required messaging can be performed by anyone). They broadcast it to everyone, aggregate the signatures in the responses and broadcast the certificate again, including to the sender. They also keep a copy of the full state, similar to (standard) validators, to be able to answer queries about account balances. A relay service can implement the Ethereum execution engine API and thus serve as an RPC provider that can be added e.g., to Metamask. Mirrors keep a copy of the state, similar to a validator relayer, but without performing validator or relayer services. They can be used e.g., to provide necessary information for ‘block explorer’ applications. Wallets are software clients that can be implemented by anyone as direct payment apps. In order to perform these services, they need different information (up-to-date, although none of the services will critically fail if they have not received the latest updates): relayers and mirrors both need to receive all certificates, to be able to fully represent the current state. Wallets need to receive all payment certificates containing selected accounts either as a sender or recipient (and checkpoint certificates where the account is a recipient of transaction fees), to be able to represent current balances for those accounts. Parties may request to be notified about certain events for a limited amount of time. It is up to whoever sends a message to decide which of those requests to honor, our recommendation (that will be coded up as the default behavior in the node client software) is to honour all such requests that provide a valid justification (running one of the services mentioned above, except if it has been observed in the past that the requester does not actually perform those services) and that have an expiry date no more than four weeks into the future. The behavior is then to simply include those parties in addition to the validators whenever a message of the requested type is broadcast. Subscribe messages S take the following form:
a. [Messages]: an array specifying the types of messages to receive; these can be payment, governance, and checkpoint certificates; parties may also specify to only receive payment and checkpoint messages relating to certain accounts.
b. Expiry: a UNIX date that should lie no more than four weeks into the future.
c. Justification: subscribers can specify whether they are running a relayer, mirror, archive mirror or wallet service.

One problem with the payment system as described above is that Byzantine behavior by the sender can lead to their account getting permanently locked. This can happen if the sender signs different transactions with the same nonce and sends it to different validators. If enough validators sign different messages with the same nonce, it can lead to a situation where it is no longer possible to reach a quorum for any of the messages. Since validators can also not sign any new messages with a higher nonce, this means that the account is effectively locked forever and the funds in the account can no longer be moved.

Some embodiments address this issue by introducing a new kind of recovery certificate R. A recovery certificate contains an array of messages with the same nonce, together with their signatures, that proves that it is impossible to reach a quorum for any of the messages. Concretely, this means that for each member of the recovery transaction set, it must hold true that the unique signatures, with the same epoch, for all the other messages combined form a sub-quorum (a formal definition of a recovery message follows in chapter 3). Similar to payment certificates, valid recovery certificates are immediately final.

In some embodiments, validators who see such a valid recovery message increase the nonce for the affected account and remove any pending transactions they might have for that nonce, thereby making it possible for new transactions by that account to be signed again. That is, if the account has a sufficient balance to pay for the associated fees, G.RecoveryFee (for the last epoch in the set) times the total number of recipients across all messages in R (cancellation messages are counted as having one recipient). The resulting fee is higher than for an honest payment transaction, to acknowledge the fact that it is due to Byzantine behavior by the sender and has created more network load than an honest transaction, but it would usually still be very low in absolute terms (typically below $1).

In some embodiments, signatures for different transactions with the same counter are not the only reason why an account might be unable to effect new transactions. This could also happen e.g., if they have signed a transaction with a payment higher than their current balance—in this case they could not effect new transactions until they have a sufficient balance and the transaction can be processed.

In some embodiments, if account owners do not want to wait for this, our protocol offers a different option: they can send a cancellation message C. A cancellation message has the same fields as a payment message, except for Recipients and Amount. Validators treat it similarly to a payment message, signing it if it is correct, and it becomes a final certificate once it has reached a quorum. The fee for cancelling a transaction, G.CancellationFee, would typically be higher than for a payment transaction, to reflect the fact that it likely generated more network traffic (but again, very low in absolute terms, typically). Another important difference between cancellation and payment messages is that the former take precedence over any pending payment messages-validators can sign a cancellation message, even if they already have pending messages with the same counter for the same account. But they cannot sign a cancellation message if they have already signed some message with the same nonce with any epoch. Cancellation messages may also be included in a recovery message, so there is always a path to unlocking a stalled account (as long as the account has a sufficient balance to pay the fees).

In some embodiments, it is possible that multiple certificates with different validator sets from different epochs exist for the same transaction. So the fees cannot be distributed until there is agreement on a unique certificate for each transaction. This problem is closely related to a different one, that of creating a checkpoint. In a checkpoint, validators agree on the current state, allowing them to discard all previous transactions from memory, thus addressing the issue that storage requirements grow linearly in the number of transactions. This problem is known in the literature as a consistent global snapshot, but our problem features some additional complexities that stem from the interplay between the asynchronous payment system and the requirement that the finality of payments shall not depend on consensus, as well as the possibility of committee reconfiguration. Any consensus algorithm could likely be adapted to this problem. Some embodiments use a leaderless snapshot algorithm that addresses all our requirements:
a. Initiate: Any node observing that length of the [Transactions] array in its local state matches G.MinTxToCheckpoint for the current epoch creates a checkpoint proposal: it creates a temporary copy of its current [Transactions] array, [Transactions'], creating an efficient representation for it2. It signs the hash of the transactions concatenated with the current checkpoint and epoch IDs, and sends this signed proposal to all validators. The validator also includes a copy of each transaction it has signed, but for which it has not yet seen a certificate in its initial proposal. At the same time, it stops signing transactions with the current checkpoint ID and seamlessly starts signing with the next checkpoint ID (transactions that were signed with the old checkpoint ID may be signed again with the new checkpoint ID, similar as for epochs).
b. Propose: A node who has not yet sent out a checkpoint proposal and receives the first such proposal first verifies it for syntactical correctness: syntactically correct proposals include at least G.MinTxToCheckpoint transactions, they increment the last checkpoint ID by one, it contains only transactions with correct certificates with checkpoint IDs up to the last one, and those transactions increment the sender account nonces by one (with respect to the state in the last Checkpoint, not in the current Accounts). Upon the first correct proposal received, a node switches to signing transactions with the next checkpoint ID, just as the initiating node. The receiving node creates the union set of the transactions in its own [Transactions] array and of those in the received proposal. This becomes its own version of [Transactions'], for which it sends out its own signed proposal. In the first proposal, validators also include a copy of each transaction they have signed, but for which they have not yet seen a certificate.
c. Re-Propose: After they have sent out their first proposal, nodes continuously monitor, process and store incoming proposals. Any proposals that contain transactions not included in the node's previous proposals get added to [Transactions'] and trigger a new checkpoint proposal sent by that node (any new proposal sent by a node must contain a true superset of transactions compared to its last proposal—this is another correctness check performed by all receiving nodes). Validators immediately apply the effects of transactions that were not included in their own Transactions array to the Accounts in their state.
d. Checkpoint proposals are also triggered if a new governance proposal is made, and checkpoint proposals that include a new governance certificate are syntactically correct independently of whether they contain G.MinTxToCheckpoint transactions. Validators treat such a proposal similar to how they treat any other proposal. If they have not yet seen a proposal with the same epoch and checkpoint IDs, they treat it as a new initial proposal. If they have already made a checkpoint proposal, they create the union between their last checkpoint proposal and the new one, and if the governance proposal contains any new transactions, they trigger a new checkpoint proposal, just as they would with any received checkpoint proposal.
e. Process: validators process a checkpoint once they observe a quorum of signatures for a proposal (with respect to the epoch referenced in the proposal). They apply the transactions in the checkpoint to the state at the last Checkpoint in their state, creating a new temporary variable Checkpoint′, and record the effects of distributing transaction fees to validators' wallets—the exact process for the latter is laid out below.
f. Lock: After having processed the checkpoint, validators hash the state of the accounts in the Checkpoint′ and sign it. They send out a lock message containing their signature of the checkpoint hash, as well as the aggregated signatures for the proposal and the transactions contained therein.
g. [if required] Unlock: if a validator sees that different lock messages have gathered enough signatures each, such that neither can reach a quorum, they construct an unlock message. Unlock messages contain a proof that a quorum is impossible, analogous to a recovery certificate (see sub-chapter 2.3). They also attach a new checkpoint proposal containing the union set of all transactions in the unlock message. Validators who see this message treat it like they treat any proposal, and the protocol moves back to the re-propose phase.
h. Confirm: a node considers a checkpoint confirmed as soon as it sees a quorum for a lock message, or a certificate containing such a quorum. If a node has not yet seen a certificate, it creates one and sends it to all nodes.
i. Finish: following confirmation, validators process the transactions without a certificate that they have received in the initiate and propose steps, taking the union set of all such transactions. There are three possible cases for those transactions: (i) they have already received a quorum of signatures, in this case, they aggregate the signatures and add the certificate to their own [Transactions] array. (ii) They may see different transactions with the same nonce, in this case, they consider the account Byzantine and will only accept cancellation or recovery messages from this account going forward. (iii) Or they may see that a transaction has gathered some signatures in the previous period, but not enough for a quorum. In this case, they sign that transaction with the new checkpoint ID and, if the confirmed proposal includes a governance certificate, the new epoch ID. After they have finished processing all transactions, they send out the newly signed transactions to all validators and to the sender.

In some embodiments, upon confirmation of a checkpoint, validators replace their Checkpoint with the new Checkpoint′, apply the effects of fee distribution and any transactions in the checkpoint that were not yet reflected in their state to the Accounts in their state and discard the checkpointed transactions from their [Transactions] array; archive nodes add them to their [Archive]. They immediately stop signing messages with the old checkpoint ID and start signing with the new one. Validators may sign transactions that they have already signed with an old checkpoint ID, but for which they have not yet seen a certificate, again with a new checkpoint ID. This helps ensure liveness, but it may result in multiple certificates existing for the same transaction. A unique certificate for each transaction will be selected when the transaction is checkpointed, ensuring that the associated transaction fees are only paid out once.

In some embodiments, transaction fee distribution could happen in many different ways. The reward mechanism is important to ensure incentive alignment, e.e., making sure that only validators who actually contribute to the protocol get rewarded. This is where identifiable signature aggregation, mentioned in chapter 1 can be of help: it allows validators to see which other validators participated in signing certificates. This could be used to design a proof-of-participation reward model, where validators are rewarded proportional to how many of their signatures are contained in the checkpoint. The governance mechanism makes such complex calculations superfluous, as it allows validators to agree on removing nodes who do not participate in signing transactions. Some embodiments use a simpler fee distribution mechanism that distributes fees equally among all validators in an epoch, while subtracting a fixed percentage cut as the operator fee share (which effectively gets burnt): validators use the governance certificates corresponding to each epoch to compute the transaction fees available for redistribution for each epoch contained in the checkpoint. In case multiple certificates for the same transaction exist, validators must use the one with the lower resulting fees for the user (this has important safety implications), and among those with the same transaction fees the one with the lowest epoch number. They add the newly available fees to the currently undistributed fees according to their [Epochs] array. Call this sum Fees-then the amount that is credited to each validator for the respective epoch is then given by an equation, where the operator fee share is interpreted as a percentage, and any remainder is stored in the [Epochs] array again. It is worth noting that even if anonymous aggregation is used, there exist other ways to collect data on validator participation, e.g., at relayers.

In some embodiments, one modification to the transaction fee distribution would be to distribute fees only for the current epoch, meaning that the transaction fees for transactions checkpointed after their epoch would de facto be burnt, which is similar in effect to a slightly higher operator fee share. The benefit of this design would be that validators would not have to store governance certificates and undistributed fee amounts for all previous epochs, avoiding linear growth in memory requirements. A compromise would be to store governance certificates for a fixed number of previous epochs, reflecting the fact that it becomes increasingly unlikely that old transaction certificates still appear.

In some embodiments, protocol governance fulfills several functions: updating the validator list as validators enter and leave, allowing validators to rotate keys, updating fee parameters to ensure economic viability, updating the list of banned accounts to ensure compliance or updating the software for maintenance or to bring in new features. Governance certificates increment the epoch ID once they become effective. The process for an epoch transition involves making a checkpoint and it can be thought of as a checkpoint where, in addition, governance parameters may change. The reason some embodiments create a separate sub-system for epoch transitions is that checkpoints are meant to be done regularly to support the operation of the protocol. By separating the two processes, some embodiments gain that the agreement process on governance proposals does not impact the operation of the rest of the system, including the checkpoints.

In some embodiments, the union set all=Ve∪Ve+1 of all validators in the previous and the next epoch can be partitioned into {old, new, out}, where old=Ve∩Ve+1 is the set of validators who remain on the committee, new=Ve+1\Ve is the set of newly added validators and out=Ve\Ve+1 is the set of removed validators. The process for an epoch transition for the validators in Ve looks as follows:
a. Initiate: The operator creates a governance proposal G for epoch e+1, signs it, and sends it to all nodes in Ve.
b. Sign: Validators in Ve sign G and send it back to the operator.
c. Confirm: After G has reached a quorum, the operator aggregates the signatures and sends out the resulting governance certificate to validators in Ve, triggering a checkpoint. Any validator who sees this immediately stops signing any transactions with the current checkpoint or epoch ID.
d. Send: after the checkpoint is finished, validators in Ve send new validators the governance certificate, the confirmation certificate for the checkpoint, the certificates for all transactions they may have that are not included in the last epoch's checkpoint, and a copy of each transaction they have signed, but for no certificate was included in the checkpoint.

In some embodiments, only old validators commence signing transactions with the new epoch and checkpoint ID: if the validator set size has remained the same or increased compared to the last governance certificate, old validators immediately start signing transactions with the new governance and checkpoint IDs. There is no pause after confirming the governance certificate. If the validator set size has reduced, they stop signing any messages and start buffering incoming transactions while the checkpoint process is ongoing. In this case, they wait until they have finished the checkpoint to start signing transactions with the new checkpoint and epoch IDs, incrementing both IDs.

In some embodiments, validators may also use the governance process to rotate their signing keys. They may use a KeyRotation message (consisting of the old and new key and signed with both keys) to inform the operator of this intent, who will include their new key and remove their old one from G. These validators participate in the process with their old key and follow the same process as members of old. new validators perform bootstrapping:
a. Query: as soon as they receive the first governance certificate, they start querying random validators in Ve to receive a copy of the full state at the referenced Checkpoint.
b. Confirm: they wait until they have received a quorum of governance certificates to confirm that they have received a copy of the correct checkpoint (the checkpoint itself can be verified by its hash included in the confirmation certificate).
c. Process: following confirmation, new validators create the union set of all transaction certificates that they have received, thus creating their initial [Transactions] array. They also apply the effects of these transactions to the state in the Checkpoint, thereby creating their initial copy of Accounts. Regarding the signed transactions without certificates, new validators perform the same routine as in the finishing step of a checkpoint. Only then do they start signing new transactions.

In some embodiments, client software comes in different forms, for the various roles in the system (validators and mirrors with or without archives, relayers and wallets). Crucial to the correctness of the protocol and its implementation is the software run by validators. Some embodiments implement this client in Rust, a modern language that emphasizes security and speed, making it ideal for our use case. Rust is also favored by other recent blockchain projects emphasizing high capacity and fast finality. The software for a mirror client is similar to that for a validator, the main difference being that all active functions such as signing payments are disabled.

In some embodiments, compatibility with the Ethereum Virtual Machine (EVM) is a usability consideration that is important for adoption. What this means concretely, in the absence of smart contracts, is that it is possible to issue payment transactions on the native system using Metamask and similar software. From a technical perspective, this requires implementing the relevant parts of the Ethereum execution JSON RPC API (this includes endpoints such as eth sendTransaction—see the API specification, documentation and code as well as the Metamask developer documentation). Exposing this API will be the job of the relayers (which could be coupled with running a validator node but need not be)—the relayer client will implement the Ethereum API and any live instance can serve as the RPC endpoint that users can add to Metamask, as they would add any other EVM-based alt-chain (Polygon, Avalanche C-Chain, Arbitrum, . . . ). Another element of EVM-compatibility is that some embodiments will use the same elliptic curve signature scheme as Ethereum and account addresses that consist of the last 20 bytes of the Keccak-256 hash of the public key. This means that users can use the same accounts/keys that they may already be using in Metamask for Ethereum and other EVM chains. This has two important implications. The first is a legal one, namely that the list of banned accounts for our system will be the same as for Ethereum (i.e., the OFAC list). The second concerns post-quantum security.

In some embodiments, relayer services are trustless and can be offered by anyone. At least one such service should be offered by the operator to guarantee that Metamask users have an available RPC endpoint, that can use the revenues from the operator fee share to finance its operation. Wallet software serves to integrate payments on the native system with other apps and is intended to be implemented by different parties. The required implementation effort is low, mainly consisting of providing users with means to sign payment messages, either on behalf of an account owned by the app's operator or on behalf of user's accounts. Any third-party app that integrates payments on the native system would fall in this category.

In some embodiments, the only element that is crucial for post-quantum security in a design are the signatures—here some embodiments may use post-quantum-secure signatures from the start. Some embodiments will support the same elliptic curve as Ethereum. It can be assumed that Ethereum will switch to a post-quantum resistant scheme once quantum security does become a real concern. Some embodiments provide an optional field where senders can specify the signature scheme they used, which provides maximum flexibility for supporting multiple signature schemes, including quantum-resistant ones, from the start.

In some embodiments, broadcast-based payments are “embarrassingly parallel”, and this can be exploited through node-level sharding. This is a technique where each validator runs multiple machines, allowing them to parallelize the processing of transactions. This is necessary because the bottleneck in such systems is, effectively, no longer the consensus mechanism (as in most established blockchains) but the limitations of the hardware-a single CPU core will struggle to handle 100 k+ transactions per second, even with a centralized database design. Recent experiments have shown that node-level sharding can be used to increase throughput almost linearly, with the latest records standing at over half a million TPS.

In some embodiments, another usability feature for users is the ability to use the native token as an ERC-20 token on Ethereum, or its equivalent on other chains. The “canonical” representation of the token created by the mint wallet has the same quality as the original tokens on the native chain and is fully backed by balances on the native chain. The service can be offered permissionless, using the same signature scheme as for payments on the respective underlying chain from which funds are being sent. Fees on the destination chain are paid for by the sender using the native fee mechanism, and fees on the target chain are subtracted from the transferred amount by the operator (meaning that there will be a minimum transfer amount). An API service by the operator can be integrated into web/mobile apps.

In some embodiments, full consensus is not needed to maintain a payment system with BFT guarantees. Unlike smart contract transactions, payment transactions need not be totally ordered to achieve finality. This opens up the path to more scalable BFT payment systems than Bitcoin, which totally orders transactions and suffers from low throughput, high latency and a lack of finality. Systems that do not apply total ordering can finalize valid payments asynchronously with a single instance of Byzantine reliable broadcast or Byzantine consistent broadcast of a signed transaction. The latter involves no direct communication between validators, substantially reducing the number of messages required and the time to finality compared to consensus-based blockchains.

Some embodiments rely on a fixed validator set. Some embodiments also perform extensive performance evaluations using a Rust-based client operating in a globally distributed system. They report capacity levels of around 100 k TPS with latency around 100 ms and high resilience to node failures. They compare the impact of BLS signature aggregation, which adds computation costs but reduces message size to O(1) in the number of validators (and destroys information that is useful for monitoring validator participation). They find that below a cut-off of about 100 validators, sending unaggregated signatures offers better performance than signature aggregation. They also examine performance gains due to node-level sharding, showing capacity increases to 160 k TPS with negligible impact on latency.

Some embodiments provide an account-based payment system, based on BCB, with checkpointing and transaction fees, that addresses several limitations faced by the above systems. Some embodiments address a liveness issue that plagues all of the broadcast-based systems: faulty behavior by a sender may, in some cases, lead to their accounts getting permanently locked and unable to effect any transactions in perpetuity. Conventional works argue that account locking is not a problem as it is due to faulty behavior on the sender's part. Some embodiments allow account owners to recover from such faulty behavior. Our solution for account unlocking works fully asynchronously, piggy-backing on the established BCB mechanism. Checkpointing is important to ensure practical operability of the system under high loads, by allowing to discard transactions from memory. It amounts to taking a global consistent snapshot. Some embodiments allow continuing to process transactions without interruption if a snapshot is taken. Some embodiments do not force transactions for which processing started before the checkpoint to be finished before the checkpoint. For epoch transitions, some embodiments combine this snapshot algorithm with a committee reconfiguration. This is critical because committee reconfiguration generally requires consensus for safety before transaction processing can continue. Some embodiments guarantee safety in cases (notably, when the validator set size does not shrink) even if not all transactions from the previous epoch are included in the consensus. This means that, at least when the size of the validator set does not shrink, the processing of transactions need not be paused for committee reconfiguration. If the validator set size shrinks, some embodiments pause the processing of transactions until all transactions from the previous epoch have finished processing. Further features that are important for using FinalPay as a real-world payment system, and that are rare or novel among broadcast-based BFT payment systems, are charging and redistributing transaction fees, governance, and provisions for complying with banned account regulations.

Ephemeral nonces and governance alternatives of some embodiments: in some embodiments, nonces, as used in Ethereum's account model, have some drawbacks with regard to memory requirements. Storing nonces requires more memory than storing only balances, and since nonces are not reset after a checkpoint or epoch change, they have to be kept in memory even for inactive accounts. This could be avoided by making the checkpoint and/or epoch ID part of the transaction that is signed by the user. This means that signed transactions are only valid within one epoch and checkpoint, and nonces can be reset to zero after a checkpoint or in a new epoch. EVM-compatibility could be preserved in this model by using some of the leading bits of the 256-bit EVM nonce for epoch and checkpoint IDs, and only the remaining bits for the transaction counter. It would also include pausing the processing of transactions on each checkpoint and ensuring that all transactions from the last epoch are collected before the new one starts. This can be achieved within the presented snapshot algorithm by asking validators to sign and broadcast any valid transactions which they first see during the proposal phase. Other possible changes to the signature system include merging checkpoints and epoch transitions into a single operation or not requiring a vote by validators on governance proposals, allowing governance proposals by anyone or not requiring an operator signature for checkpoint proposals and including them in the consensus instead.

Smart contracts of some embodiments: in some embodiments, while FinalPay was optimized for payments with instant finality, it is possible to combine it with smart contract transactions while preserving instant finality. Smart contract transactions require total ordering of transactions and thus consensus, hence smart contract transactions can only be processed during checkpoints. Some embodiments enable payment finality before a checkpoint is confirmed because both payments and smart contract transactions can spend user's funds. To ensure that any payment with a certificate is valid independently of what happens in smart contract transactions, all payments should be included in a checkpoint and payment processing paused on checkpoint transitions as in the ephemeral nonce model above. But this alone may not be sufficient to guarantee finality, as payments also compete with smart contract transactions within the same checkpoint period. Some embodiments mitigate this by choosing any deterministic rule that gives priority to payments over smart contract transactions in a checkpoint, such as sorting all payments before smart contract transactions in the total ordering. Whether smart contract transactions fail or succeed then depends on the balances after all payment transactions within a checkpoint have been processed.

Alternative consensus mechanisms of some embodiments: in some embodiments, the snapshot algorithm used in the checkpoints could be replaced with any number of consensus mechanisms. One alternative would be practical Byzantine Fault Tolerance (PBFT). PBFT consensus requires a leader, but pseudorandom leader rotation is sufficient to maintain BFT guarantees, an example of a usable rule would be to cycle through the validator list in the current governance certificate. Having a leader allows skipping the re-propose and unlock phases but requires a separate leader change process, where validators agree on the next leader after a pre-defined time-out period. In case completeness is required, e.g., for smart contracts, re-proposals are needed again. Other possible consensus mechanisms include exponential information gathering, Tendermint, Narwhal/Bullshark, and generally all BFT consensus algorithms (where authenticated nodes may be assumed in BFT proofs) can be adapted for this use case.

UTXOs and privacy features of some embodiments: in some embodiments, unspent transaction outputs represent an alternative approach to tracking user balances compared to an account model. Transactions consume one or more UTXOs and send the funds that they represent to one or more new addresses, thereby creating new UTXOs. In some embodiments, all elements of FinalPay can be used with UTXOs instead of an account model: payment and cancellation transactions are immediately final once they reached a quorum, and recovery messages can be constructed analogously. Checkpoints agree on the current state of UTXOs, allowing to discard the history, and epoch transitions do not require further adaption. Transaction fees are charged by ensuring that the sum of UTXOs is less than the consumed UTXOs and distributed in a checkpoint by creating UTXOs without inputs. UTXOs may also be created with stealth addresses, where only recipients or parties with whom they have shared their scanning private keys, have the ability to verify the owner account of a UTXO, thereby providing transaction privacy. Other alternatives for providing privacy include signing zero knowledge computation certificates instead of transactions, masking even the existence of balance. Such privacy-enhancing features may also be combined with the ability for e.g., the operator to reveal balances or transactions, e.g., by using threshold signatures.

Transaction reversals of some embodiments: in some embodiments, the ability to dispute payments is an important safety feature in modern payment systems. This can be achieved by either delaying finality until some pre-defined conditions, e.g., elapsed time or operator approval are met, or by granting the operator the ability to create new transactions from any account that have the effect of reversing transactions. Granting such abilities requires substantial trust in the operator and should be accompanied by a strong governance framework.

Different wallet designs of some embodiments: the reliance on a single, private key creates risks regarding both the safety and the recoverability of those keys: if a key is not sufficiently secured by the user, anyone who obtains it can issue transactions as if they were the account owner and potentially steal all funds. Conversely, if a key is kept very securely but then lost by its owner, they lose the ability to access their funds. Secret sharing is a cryptographic technique that allows mitigating those risks by splitting up a secret into n parts such that any size-k subset can be used to restore the full secret, where both k≤nϵN+ can be chosen arbitrarily. Secret sharing makes use of the mathematical fact that any degree-(k−1) polynomial over the reals can be fully and uniquely reconstructed using k distinct points on the polynomial. It works by simply sharing n distinct points on a degree-(k−1) polynomial whose coefficients encode the secret in some deterministic scheme. This can be used to improve security by sharing a private key, e.g., among multiple devices, enabling multi-factor authentication, or multi-sig wallets, where multiple parties need to agree to a transaction. Multi-sig schemes could be used, eg, to require committee approval for transactions, or to task a separate entity to monitor transactions for fraud risk, and to only provide a signature if the risk is deemed sufficiently low (potentially coupled with an insurance product). Secret sharing can also be used to address recoverability risks, e.g., by designating a set of trusted parties who can collectively authorize changing the public key of a wallet (or, equivalently, moving the funds to a new account). Both multi-sig wallets and social recovery can be built as an abstraction by on top of the protocol by a wallet software, or be supported directly by the protocol itself.

Proof-of-stake and decentralization of some embodiments: having an operator is not required for FinalPay and it can also be used to power a decentralized cryptocurrency. Protection against sybil attacks, where attackers create multiple validator identities, is commonly achieved using PoS in decentralized cryptocurrencies, where the >⅔ requirement for a certificate refers to a weighted vote by validators, with weights proportional to staked amounts. Epoch transitions are triggered by special staking and unstaking transactions, where validators lock up their funds in the protocol. Those staking transactions also serve the purpose of communicating the validator's public key. Proof-of-stake can be used in conjunction with a centralized mint, as in our presentation, but different ‘Tokenomics’ that distribute newly created funds to validators according to pre-defined rules are more commonly used. Typically, such rewards are proportional to the stake, and may also include penalties for non-responsiveness or other Byzantine behavior, which can be proved if identifiable signature aggregation is used.

Classic payment systems are usually run by one organization, or by a set of entities who mutually trust each other. The FinalPay protocol may also be useful in such scenarios where malicious attacks by system participants are no concern. In modern systems, work is practically always distributed among multiple processes on the same or on multiple machines. These processes may fail for a variety of reasons that need not be related to malicious attacks, e.g. hardware failures or failed updates. Byzantine fault tolerance guarantees the safety and liveness of the system even in such situations. FinalPay may thus be used as a backend solution for centralized payment systems that enhances security by providing BFT security guarantees, while also substantially increasing the throughput compared to existing real-time gross settlement systems. When FinalPay is used in such contexts, it may be possible to use FinalPay without any transaction fees, at least at the protocol level.

In some embodiments, FinalPay as a payments layer for tokens on other blockchains: FinalPay can also be used as a layer-2 solution to allow for efficient transfers of tokens represented on another blockchain such as Ethereum. In this case, a smart contract on the source blockchain would play a role similar to the operator, issuing minting an burning transactions and charging transaction fees to cover fees for updating the smart contract state on the source chain. Such a smart contract could handle multiple tokens, including e.g. native Ether and ERC-20, with parallel instances of FinalPay to handle payments in each token.

Data storage, and extra features enabled by storage of some embodiments: the transaction system may also include special transaction types that allow users to store extra data, optionally associating them to their accounts. Data storage may be permanent or time-based, and can power various extra features, such as account limits, e.g., for maximum outgoing payment volume per time period as an extra safety feature. Usability features that rely on stored data include e.g., account identifiers, such as hashed mobile phone numbers, which could enable mobile payment apps that allow sending money directly to phone contacts, if they use this feature. Data storage can also be used to support other features such as allowing transaction fees to be paid by other accounts, or to support different wallet designs such as social recovery, mentioned above.

### Authorizations in Data Transmission Systems

One important feature in a data transmission system (e.g., a cryptographic transmission system described herein with reference to FIGS. 1-16) is the capability for users to grant other users authorization to make transmission on their behalf in the data transmission system. For example, the data transmission system may need to provide the capability to perform an auto-debit transaction in which one user of the data transmission system needs the authority to automatically debit an amount of a UTM (e.g., a cryptographic token or coin) from another user. As an illustrative scenario, the second user may be paying for a monthly subscription through the data transmission system. The first user may need the authority to debit the second user monthly for the subscription. As another example, the data transmission system may need to provide the capability to hold or reserve an amount of a UTM from one user for another user. As an illustrative scenario, a first user may make a reservation from a second user for a future time period (e.g., for a hotel reservation). In this scenario, the second user may need a guarantee that the first user can be debited an amount for the reservation at the future time period (e.g., to pay for the hotel reservation). The second user may thus need authorization to debit the first user at the future time period for a particular amount of a UTM.

Conventional data transmission systems are inefficient and restrictive in their authorization capabilities. Conventional data transmission systems rely on smart contracts to provide authorization capability. However, smart contracts increase the risk of fraud and error in a data transmission system. Smart contracts need to be programmed by users, and are thus susceptible to errors introduced by users during programming. Smart contracts are simply executed without any validation of the operations encoded by the smart contract. Smart contracts do not have a standardized way of providing authorization functionality. For example, ERC20 and ERC721 are standards that define specific smart contract functions. But these standards are not enforced and thus users may violate the standards or otherwise implement a smart contract differently than specified by the standards. Accordingly, smart contracts could be encoded to fraudulently or errantly grant one user authorization to perform transmissions on behalf of another user. Moreover, performing authorization through smart contracts is inefficient as each authorization is encoded as a separate executable application that needs to be stored and processed. This requires memory for storing the smart contracts and processing capacity to execute the smart contracts. Another limitation of authorization functionality in conventional data transmission systems is that it can only be done for one resource (e.g., one coin/token) in the data transmission system.

Accordingly, described herein are techniques for providing authorization capability in a data transmission system that is more secure, efficient, and flexible than that of conventional data transmission systems. Instead of relying on smart contracts to grant authorizations, the techniques configure validation units/validators of the data transmission system to validate authorizations. The validation units verify that authorizations are valid and guarantee that rules are adhered to by the authorizations. This improves the security of authorizations by allowing validators to prohibit fraudulent or errant authorizations. Moreover, given that the data transmission system provides authorization functionality without using smart contracts, the data transmission system does not require the memory to store smart contracts or processing hardware to execute the smart contracts. Some embodiments provide the ability to efficiently revoke authorizations (e.g., in response to detecting a case of fraud). In contrast, revocation of authorization may be difficult or impossible when granted through a smart contract.

Authorization techniques described herein are performed asynchronously. The techniques do not require full consensus among validation units of a data transmission system, nor do they require communication between the validation units. This provides low-latency, high-throughput operations for granting authorizations in the data transmission system. This allows the data transmission system to grant authorizations more quickly and efficiently than conventional data transmission systems. Despite not requiring consensus amongst the validation units, the techniques still provide a de-centralized authorization validation system in which authorizations are recorded by multiple independent validators. This creates an immutable record of authorizations that can be used to verify authorized transmissions.

Some embodiments provide techniques for asynchronously allowing a user of a data transmission system to authorize another user to perform transmissions of a uniform transmission medium (UTM) from a UTM balance of the user. The data transmission system comprises validation units for validating transmissions among users of the data transmission system. The authorizing user transmits, to the validation units, an authorization for an authorized user to trigger UTM transmissions in the data transmission system from a UTM balance of the authorizing user. The validation units validate the authorization (e.g., by verifying that the authorization meets rule(s) and/or limit(s)). The system receives validation messages from at least some of the validation units indicating that the authorization is valid. When validation messages are received from at least a threshold number of the validation units, the first user is granted the authorization to trigger UTM transmissions from the UTM balance of the second user. For example, the system may generate an authorization validation certificate using validation signatures in the validation messages and transmit the authorization validation certificate to the validation units. The authorization validation certificate may be stored by the validation units and used to verify UTM transmissions from the UTM balance of the second user triggered by the first user.

Some embodiments provide techniques for asynchronously authorizing users of a data transmission system to trigger transmissions UTM transmissions from UTM balances of other users. The data transmission system comprises validation units that are configured to validate transmissions in the data transmission system. The validation units receive an authorization for a first user to trigger UTM transmissions from a UTM balance of a second user. The validation units may validate the authorization (e.g., by validating parameters of the authorization). When the authorization is determined to be valid by a threshold number of validation units, the validation units may authorize the first user to trigger transmissions from the UTM balance of the second user (e.g., by recording a record of the authorization in local copies of blockchains).

In some embodiments, the authorization may be an authorization hold in which a portion of the UTM balance of the second user is held for a period (e.g., until an expiry timepoint). The held portion of the UTM balance may be restricted such that only the first user is allowed to trigger transmissions from the portion of the UTM balance during the period. The held portion of the UTM balance may be reduced from the UTM balance such that it is guaranteed to be available for transmission by the first user. For example, an authorization hold may be used to hold a portion of an authorizing user's UTM balance for a future reservation (e.g., a future hotel reservation). The techniques provide the authorized user a guarantee that the held portion of the UTM balance will be available for a particular amount of time (e.g., for claiming by the authorized user at a later time).

In some embodiments, when the first user triggers transmissions from the UTM balance of the second user, the first user may use a nonce of the second user (e.g., by querying the second user for the nonce when triggering the transmission). In some embodiments, when the first user triggers transmissions from the UTM balance of the second user, the first user may use a nonce of the first user (e.g., by incrementing the nonce). In some embodiments, when the first user triggers transmissions from the UTM balance of the second user, the first user may use a global nonce value associated with all transmissions in the system. A nonce may be used to enforce serial ordering (e.g., by the first user, the second user, and/or globally across the system) and eliminates conflicts with other transmissions from the UTM balance of the second user (e.g., by the second user or another authorized user). The value of a nonce may be validated by the validation units of the system (e.g., by verifying that the nonce is not associated with another transmission).

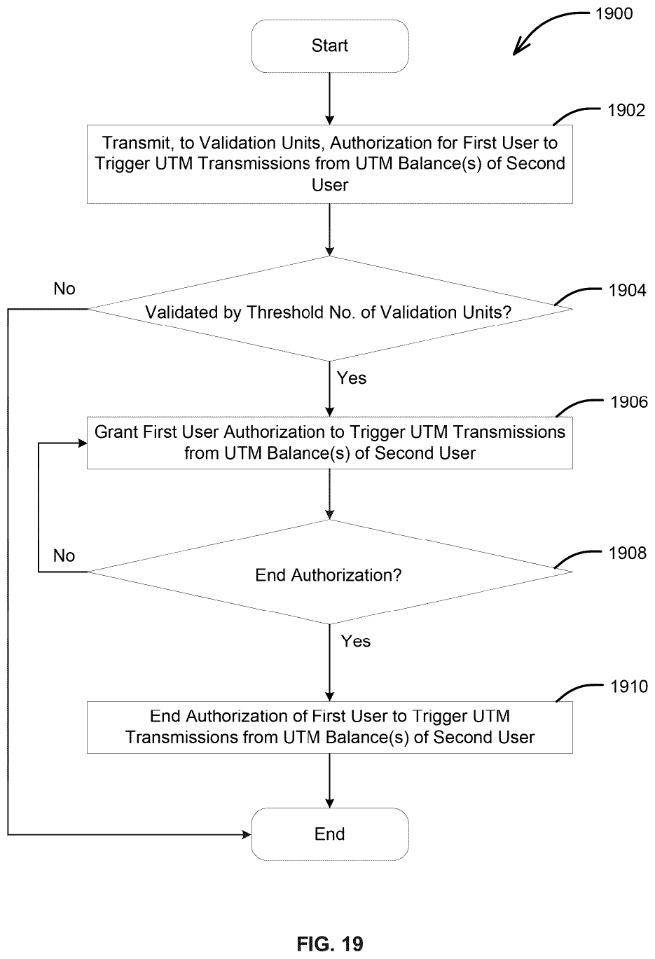

FIG. 17A depicts an example data transmission system 1700 in which users can authorize other users to perform transmissions on their behalf, according to some embodiments of the technology described herein. As shown in FIG. 17A, the data transmission system 1700 includes user devices 1702A, 1702B and validators 1710A, 1710B, 1710C. The user devices 1702A, 1702B and validators 1710A, 1710B, 1710C may be configured to communicate with each other through a communication network 1730 (e.g., the Internet). It should be appreciated that the data transmission system 1700 may include users and/or validators in addition to those illustrated in FIG. 17A.

As illustrated in FIG. 17A, the user devices 1702A, 1702B each include modules. The user device 1702A includes an authorization module 1706A and a transmission module 1708A. The user device 1702B includes an authorization module 1706B and a transmission module 1708B. Each of the modules may be implemented by a set of instructions that are executable by one or more computer hardware processors. Each of the user devices 1702A, 1702B further stores an indication of one or more UTM balances (e.g., a cryptographic token or coin balance(s)). The user device 1702A stores UTM balance(s) 1709A associated with a first user and the user device 1702B stores UTM balance(s) 1709B associated with a second user. In some embodiments, a UTM balance may represent an amount of a particular resource (e.g., a fiat currency).

In some embodiments, authorizations may be granted in the data transmission system using the same validation process that is performed for data transmissions (e.g., as described herein with reference to FIG. 5). Thus, authorizations may be granted asynchronously. Authorization may not require communication between validators. An authorizing user may be configured to transmit an authorization to the validators 1710A, 1710B, 1710C. This transmission to the validators 1710A, 1710B, 1710C may be referred to as a “broadcast”. Each of the validators 1710A, 1710B, 1710C may be configured to validate the authorization. Validation techniques for authorizations are described herein with reference to FIG. 17B. When a validator validates the authorization, the validator transmits a validation message including a validation signature to a sender (e.g., an authorization module implemented by a device associated or a relaying device). The validation signatures may be aggregated from the validation messages to generate an authorization validation certificate when a threshold number of validation signatures are obtained. The authorization validation certificate may be transmitted to the validators 1710A, 1710B, 1710C to finalize the authorization. In some embodiments, receipt of the authorization validation certificate may cause the validators 1710A, 1710B, 1710C to accept the authorization. The validators 1710A, 1710B, 1710C may store a record of the authorization (e.g., in copies of a blockchain stored in respective memories of the validators 1710A, 1710B, 1710C).

In some embodiments, the authorization module of a user device may be configured to authorize another user to trigger transmissions in the data transmission system 1700 on behalf of the user associated with the device. The authorization module may be configured to authorize another user by transmitting an authorization to the validators 1710A, 1710B, 1710C for validation. The authorization module may be configured to receive validation messages from the validators 1710A, 1710B, 1710C indicating that the authorization is valid. Validation performed by a validator is described herein with reference to the validators 1710A, 1710B, 1710C. In some embodiments, the authorization may be granted to the other user when a threshold number of validation messages have been received.

In some embodiments, the authorization module associated with a first user may be configured to generate a validation certificate and transmit the validation certificate to the validators 1710A, 1710B, 1710C. The authorization module may be configured to generate the validation certificate when a threshold number of validation messages have been received from the validators 1710A, 1710B, 1710C. For example, the authorization module may be configured to generate the validation certificate indicating that the authorization has been successfully validated by a quorum of validators. In some embodiments, transmitting the validation certificate may cause the validators 1710A, 1710B, 1710C to store a record of the authorization in local transmission records (e.g., locally stored blockchains).

In some embodiments, the authorization module may be configured to transmit an authorization by generating an authorization message and transmitting the authorization message to the validators 1710A, 1710B, 1710C. The authorization message may include various types of information. In some embodiments, the authorization message may include identifications (e.g., addresses or other identifiers) for the authorizing user and the authorized user. In some embodiments, the authorization message may include an identifier (e.g., an authorization ID) that is unique to the authorization. In some embodiments, the authorization message may include a permission configuration specifying one or more limits to the UTM transmissions that can be triggered by the authorized user. For example, the limit(s) may include a maximum amount of the UTM that can be transmitted by the authorized user from the UTM balance of the authorizing user, a maximum amount of the UTM that can be transmitted by the authorized user from the UTM balance of the authorizing user over a time period, and/or an expiry timepoint for the authorization. Below is an example description of a function that, when executed by the authorization module, causes the authorization module to transmit an authorization to the validators 1710A, 1710B, 1710C.

```
// Grants an account authorization from the sender to the
recipient with configurable limits.
function grantAuth(
  address authorizer,
  address authorized,
  string authID,
  uint256 totalCap, // Maximum total spending allowed
  uint256 monthlyLimit, // Spending limit per month uint256
  expiryTimestamp // Expiration of the authorization
) external returns (Transaction);
```

In some embodiments, the authorization module may be configured to transmit a modification to an existing authorization to the validators 1710A, 1710B, 1710C. The authorization module may be configured to generate and transmit a modification message. The modification message may indicate an identifier of the authorization to be modified and information specifying the modification. For example, the modification may include new transmission limit(s) and/or extension of an authorization time period. Below is an example description of a function that, when executed, causes the authorization module to transmit an authorization modification to the validators 1710A, 1710B, 1710C. The modification may be validated by the validators 1710A, 1710B, 1710C as the authorization is validated (e.g., a quorum of validators validating the modification results in application of the modification).

```
// Modifies an existing authorization with new parameters
(e.g., updating limits or expiration).
function modifyAuth(
  address authorizer,
  string authID,
  uint256 newTotalCap,
  uint256 newMonthlyLimit,
  uint256 newExpiryTimestamp
) external returns (Transaction);
```

In the above example authorization modification function, the function specifies an address of the authorizer, an identification of the authorization being modified, a new maximum amount authorized for transmission, a new monthly transmission limit, and a new expiration time of the authorization.

In some embodiments, the authorization module may be configured to transmit a revocation of an authorization to the validators 1710A, 1710B, 1710C. The authorization module may be configured to generate and send a revocation message to the validators 1710A, 1710B, 1710C. The revocation message may indicate an identifier for the authorization being revoked. In some embodiments, the revocation message may indicate an identifier of the authorizer who is revoking the previously granted authorization. Below is an example description of a function that, when executed, causes the authorization module to transmit an authorization revocation to the validators 1710A, 1710B, 1710C. The revocation may be validated by the validators 1710A, 1710B, 1710C as the authorization is validated (e.g., a quorum of validators validating the modification results in revocation of the authorization).

```
// Revokes an existing authorization.
function revokeAuth(
  address authorizer,
  string authID
) external returns (Transaction);
```

In some embodiments, an authorization transmitted by the authorization module may be an authorization hold in which an amount of the authorizing user's UTM balance is held for the authorized user to trigger transmissions from. The authorization hold may be granted for a limited amount of time. An authorization message for an authorization hold may thus specify an amount to be held and an expiry timepoint. In some embodiments, an authorization hold message may indicate other information such as a permission configuration specifying limit(s) on the authorization hold. The limit(s) may include, for example, a maximum number of renewals that can be granted to the authorization hold and/or a maximum time period that the authorization hold can last. Below is an example description of a function that, when executed, by the authorization module transmits an authorization hold to the validators 1710A, 1710B, 1710C.

```
// Initiates an authorization hold.
// Deducts ‘amount’ from the sender's available
balance function grantHold(
  address receiver,
  string holdId,
  uint256 amount,
  uint256 expiryTimestamp,
  uint256 maxRenewals, // User-specified limit
  uint256 maxValidity, // User-specified limit
) external returns (Transaction);
```

In the example above, the authorization hold specifies an address of the authorized user being granted the authorized hold, an identifier of the authorized hold, an amount being held, a timepoint when the authorization hold will expire, a maximum number of renewals permitted for the authorization hold, and a maximum amount of time that the authorization hold can last.

In some embodiments, the authorization module may be configured to transmit an extension to an authorization hold. Below is an example description of a function that, when executed, by the authorization module transmits an extension to the validators 1710A, 1710B, 1710C. The authorization hold extension may be validated by the validators 1710A, 1710B, 1710C as the authorization is validated (e.g., a quorum of validators validating the extension results in application of the extension).

```
// Requests an extension (renewal) of an existing hold.
// Includes the current expiry and requested extension duration.
function holdRenewRequest(
  address receiver,
  string holdId,
  uint256 currentExpiry,
  uint256 requestedExtension // Δt
) external returns (Transaction);
```

In the example above, the extension to the authorization hold specifies an addresser of the receiver (i.e., the authorized user), an identifier of the authorization hold being extended, a current expiration timepoint of the authorization hold, and a requested extension time.

In some embodiments, the authorization module may be configured to grant authorizations for one or multiple UTM balances. For example, a user may have multiple UTM balances each associated with a different resource (e.g., a different fiat currency). The authorization module may be configured to grant authorizations specific to UTM balances. In such cases, an authorized user may only trigger transmissions from UTM balance(s) for which authorization for granted. The authorized user would be unauthorized to trigger transmissions from UTM balance(s) other than those for which authorization was granted. For example, an authorization may specify the UTM balance(s) to which it applies. As another example, multiple authorizations may be granted for respective UTM balances.

In some embodiments, a transmission module (e.g., one or transmission modules 17108A, 1708B) associated with an authorized user may be configured to trigger transmissions from one or more UTM balances of an authorizing user. The transmission module may be configured to transmit a transmission message to the validators 1710A, 1710B, 1710C to trigger a transmission. For example, the transmission module may transmit a message triggering a transmission to the validators 1710A, 1710B, 1710C. The validators 1710A, 1710B, 1710C may validate the transmission and send validation messages to the transmission module if the transmission is determined to be valid (e.g., within the parameters of a granted authorization). The transmission may be executed when a threshold number of validation signatures are received (e.g., to establish a quorum of validators that validated the transmission). The transmission module may be configured to generate a validation certificate for the transmission using the validation signatures and transmit the validation certificate to the validators 1710A, 1710B, 1710C (e.g., thereby causing the validators 1710A, 1710B, 1710C to execute the transmission by recording a record of the transmission and/or update user UTM balances accordingly).

In some embodiments, the transmission module may be configured to trigger various types of transmissions. For example, the transmission module may trigger transmissions for a subscription by triggering transmissions of a particular amount at a particular frequency. As another example, the transmission module may trigger a transmission in response to a user command. As another example, the transmission module may trigger a transmission based on detection of a particular event. In some embodiments, a transmission may be a payment in the form of a UTM. In some embodiments, the transmission module may be configured to trigger transmissions from one or more UTM balances for which authorizations were granted to an authorized user.

Below is an example description of a function that, when executed, by the transmission module, triggers a transmission to claim a portion of an authorized hold (e.g., by transmitting a transmission message indicating information specified below).

```
// Allows the recipient to claim a portion (or all) of the held funds.
function claimHold(
  address recipient,
  string holdId,
  uint256 claimAmount
) external returns (Transaction);
```

As illustrated by the example function above, a transmission message that would be transmitted to the validators specifies an address of the recipient (which may be the authorized user or another user that the authorized user is making the transmission to), an identifier for the authorization hold (“holdID”), and an amount of the UTM to be transmitted (“claimAmount”).

In some embodiments, the transmission module may be configured to trigger a return of an unclaimed balance of a UTM that was held in an authorization hold to the UTM balance of the authorizing user (e.g., by removing a hold on the amount of the UTM). The transmission module may be configured to transmit, to the validators 1710A, 1710B, 1710C, a transmission that triggers a return of an unclaimed amount of the UTM. For example, the transmission module may be configured to trigger the return of the unused balance after an expiry timepoint of an authorization hold. As another example, the transmission module may be configured to trigger the return of the unclaimed amount of the UTM when a maximum time period for the authorization hold has expired. Below is a description of an example function for triggering a return of an unclaimed UTM amount from an authorization hold.

```
// Returns unclaimed funds from the hold back to the sender.
  function returnHold(
  address recipient,
  string holdId,
  uint256 returnAmount
) external returns (Transaction);
```

In the example above, execution of the function generates a transmission message for returning an unclaimed amount from an authorization hold. The transmission message may be sent to the validators 1710A, 1710B, 1710C to trigger the return of the unclaimed amount. The message may indicate an address of recipient of the unclaimed amount to the authorizing user that originally granted the authorized hold, an identifier of the authorization hold, and the amount to be returned.

In some embodiments, a transmission module associated with an authorized user in authorization may be configured to trigger transmissions from a UTM balance of the authorized user. In some embodiments, the transmission module may be configured to trigger a transmission using a nonce of the authorizing user. For example, the transmission module may query the authorizing user for a current nonce. In some embodiments, the transmission module may be configured to trigger a transmission using a nonce of the authorized user. For example, the transmission module may increment a current nonce of the authorized user. In some embodiments, the transmission module may be configured to trigger a transmission using a global nonce that is configured to be incremented by each transmission in the system. For example, the transmission module may increment the global nonce. Accordingly, the transmissions from the authorizing user's UTM balance through an authorization are serially ordered with other transmissions by the authorizing user. This allows multiple different users to trigger transmissions from a UTM balance of a particular user. The use of the authorizing user's nonce also protects contention over UTM amounts of the authorizing user such that simultaneous transmissions do not result in double transmissions or locking. In cases in which two authorized transmissions are triggered simultaneously or nearly simultaneously, an unlock operation may be performed. Example techniques for unlocking are described herein.

FIG. 17B depicts an example validator 1710 in the data transmission system of FIG. 17A, according to some embodiments of the technology described herein. The validator 1710 may be any one of the validators 1710A, 1710B, 1710C. As shown in FIG. 17B, the validator 1710 includes memory 1410, a transmission validation module 1402, a cryptographic signature module 1404, a transmission execution module 1406, and an authorization validation module 1712. The memory 1410, the transmission validation module 1402, the cryptographic signature execution module 1404, and the transmission execution module 1406 have been described herein with reference to FIGS. 14A-14B.

In some embodiments, the authorization validation module 1712 may be configured to validate authorizations in the data transmission system 1700 (e.g., indicated by messages transmitted to the validator 1700). The authorization validation module 1712 may be configured to validate a given authorization using UTM balance(s) stored in a user record of a user granting the authorization. For example, the authorization validation module 1712 may be configured to validate an authorization hold using the UTM balances by: (1) identifying UTM balance(s) of the user representing amount(s) of respective resource(s) that are to be held in the authorization hold, and (2) determine whether the UTM balance(s) are sufficient to hold the amount(s) specified in the authorization hold. For example, for an authorization hold on United States Dollars, the authorization validation module 1712 may determine whether a user's UTM balance representing an amount of United States Dollars belonging to the user is sufficient to hold the amount of the authorization hold. As another example, for an authorization hold on an amount of a commodity, the authorization validation module 1712 may determine whether a user's UTM balance representing an amount of the commodity belonging to the user is sufficient to hold the amount of the authorization hold.

In some embodiments, when an authorization is validated by the authorization validation module 1712, the authorization validation module 1712 may generate a validation message indicating that the authorization is valid. The authorization validation module 1712 may be configured to include a validation signature (e.g., generated using the cryptographic signature module 1404) in the validation message indicating that the authorization is valid. The authorization validation module 1712 may be configured to transmit the validation message to a sender (e.g., a device associated with an authorizing user or another device that sent the authorization).

In some embodiments, the authorization validation module 1712 may be configured to grant an authorization after receiving a validation certificate indicating that the authorization has been validated by a threshold number of validators (e.g., a quorum of validators). The authorization validation module 1712 may be configured to grant the authorization by storing a record of the authorization in a transmission record 1714 stored in the memory 1410. For example, the transmission record 1714 may be a blockchain of transmission and authorization records and the authorization validation module 1712 may add a block representing the authorization. The record of the authorization may be immutable such that it can be later referenced to verify subsequent transmissions.

In some embodiment, the authorization validation module 1712 may be configured to grant the authorization by restricting access to an amount indicated by the authorization (e.g., an amount of UTM to be held for an authorization hold). The authorization validation module 1712 may be configured to restrict access to the held amount such that only the authorized user can trigger transmissions of the held UTM amount for the period that the authorized hold is in effect (e.g., before an expiry timepoint).

In some embodiments, the transmission validation module 1402 may be further configured to validate transmissions triggered by an authorized user from a UTM balance of an authorizing user. The transmission validation module 1402 may be configured to validate such a transmission by: (1) determining whether the user triggering the transmission is authorized to do so, and (2) whether the UTM balance of the authorizing user is sufficient to trigger the transmission. The transmission validation module 1402 may be configured to determine whether the user triggering the transmission is authorized to do so by checking whether a previously granted authorization is in effect. The transmission validation module 1402 may, for example, check the transmission record 1714 to identify the authorization (e.g., which may be specified in the transmission). The transmission validation module 1402 may be configured to verify that the transmission meets the parameters of the authorization (e.g., that the transmission is within amount and/or time limits of the authorization). Although not illustrated in FIG. 17B, in some embodiments, the memory 1410 may include a tracking record of authorizations. The transmission validation module 1402 may be configured to use the record authorizations to validate transmissions in which one user triggers a transmission from a UTM balance of another user.

In some embodiments a device of the data transmission system 1700 (e.g., a validator, user device, or another device) may be configured to receive queries for authorizations granted to users. For example, the device may be configured to receive a query for current authorizations granted to the first user 1702A. The device may be configured to respond to such queries. In some embodiments, the device may be configured to generate a response a response to a query. The device may be configured to generate a response by identifying any authorization(s) granted to the user. For example, the device may check a transmission record for valid authorization(s) granted to the user. As another example, the device may check a record of valid authorizations across all users for any authorization(s) granted to the user. The device may be configured to transmit a response to the query indicating authorization(s) that are granted to the user.

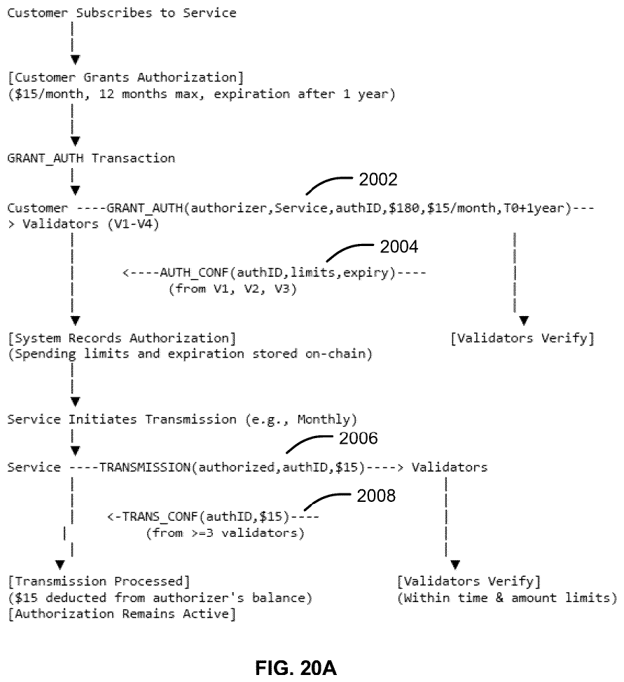

FIG. 18 shows a flowchart of an example process 1800 for validators of a data transmission system to grant an authorization for a first user to perform transmissions on behalf of a second user, according to some embodiments of the technology described herein. In some embodiments, the process 1800 may be performed by validation units of a data transmission system (e.g., a cryptographic transmission system). For example, the process 1800 may be performed by the validators 1710A, 1710B, 1710C of the data transmission system 1700 described herein with reference to FIGS. 17A-17B.

Process 1800 begins at step 1802, where the validation units receive an authorization for a first user to trigger transmissions from a second user. The authorization may allow the first user to trigger transmissions of a UTM from a UTM balance of the second user. In some embodiments, the authorization may comprise an authorization hold in which a portion of the second user's UTM balance is held. The first user may be authorized trigger transmissions from the held portion of the second user's UTM balance (but not the rest of the second user's UTM balance). In some embodiments, the authorization hold may include an indication of an expiry timepoint. For example, the authorization hold may indicate a time of expiration or a time period after which the authorization hold will expire.

In some embodiments, the authorization received by the validation units may indicate one or more limits to the authorization. For example, the authorization may indicate a maximum amount of time that the authorization can last, a maximum number of extensions that can be made to the authorization, a maximum amount of transmissions that can be made by the first user, a maximum amount of the UTM that can be transmitted by the first user over a period of time, a maximum total amount of the UTM that can be transmitted by the first user, and/or a maximum number of transmissions that can be triggered by the first user. In some embodiments, the authorization may include other limits in addition to or instead of those mentioned herein.

In some embodiments, the authorization may indicate one or more of a plurality of UTM balances of the second user from which the first user is authorized to trigger transmissions from. The second user may have multiple UTM balances stored by the validation units (e.g., associated with different resources). The authorization may indicate identifiers for the particular UTM balance(s) that the first user is authorized to trigger transmission from. For example, the second user may have multiple UTM balances associated with amounts of respective fiat currencies belonging to the second user. The authorization may allow the first user to trigger transmissions from a UTM balance associated with an amount of USD belonging to the second user and a UTM balance associated with an amount of Euros belonging to the second user. The authorization may not allow the first user to trigger transmissions from other UTM balances of the second user.

Next, process 1800 proceeds to step 1804, where the validation units determine whether the authorization received at step 1802 is valid. The validation units may each be configured to validate the authorization. Example validation that may be performed by a validation unit are described herein with reference to the authorization validation module 1712 of the validator 1710 described herein with reference to FIG. 17B. In some embodiments, a validation unit may be configured to validate the authorization by determining whether the second user has a sufficient amount in a UTM balance that the first user is being authorized to trigger transmissions from. For example, the authorization may be an authorization hold and the validation unit may determine whether the second user has at least the UTM amount to be held out in the UTM balance. In some embodiments, the validation unit may be configured to validate the authorization by determining whether the authorization meets one or more authorization rules and/or limits. For example, the validation unit may determine whether the authorization meets an amount limit, a time limit, and/or a limit of number of simultaneous authorizations. As another example, the validation unit may determine whether there is a conflicting authorization identifier. As another example, the validation unit may check whether the authorizing user or authorized user are blocked from authorizing or being authorized (e.g., blacklisted). As another example, the validation unit may determine whether an expiry timestamp specified by the authorization is in the past.

If a threshold number of validation units do not validate the authorization at step 1804, then process 1800 ends. If the threshold number of validation units validate the authorization at block 1804, then process 1800 may proceed to step 1806. For example, when a threshold number of the validation units (e.g., a quorum) transmit validation messages including validation signatures to a sender of the authorization, the authorization may be granted to the first user. In some embodiments, the validation units may receive an authorization validation certificate from the sender indicating that the authorization has been validated by a threshold number of the validation units. When the authorization has been granted, at step 1806, the validation units authorize the first user trigger UTM transmissions from the first user. In some embodiments, the transmissions that may be triggered may be limited by a permission configuration of the authorization specifying limit(s).

In some embodiments, a validation unit may be configured to grant an authorization by storing a record of a received authorization validation certificate. The validation unit may be configured to store the record of the authorization validation certificate in its memory. For example, the validation unit may store the record in a record of transmissions (e.g., a blockchain). As another example, the validation unit may store the record in a record of active authorizations. In some embodiments, the validation unit may be configured to validate transmissions triggered by the first user from UTM balance(s) of the second user using the authentication validation certificate. For example, the validation unit may verify that the first user is authorized to trigger a given transmission by verifying whether there is a valid authorization validation certificate granting the first user authorization. In some embodiments, the authorization validation certificate may indicate limit(s) to the authorization and the validation unit may be configured to validate transmissions based on the limit(s).

A validation unit may be configured to validate transmissions triggered by the first user from UTM balance(s) of the second user. A transmission triggered by the first user from a UTM balance of the second user may need to be validated by a threshold number of the validation units to be executed. Example techniques for validating a transmission are described herein. In some embodiments, a validation unit may be configured to validate a triggered transmission by determining whether the amount of the transmission meets limit(s) of the authorization (e.g., whether it is less than a held amount of the UTM, a maximum amount permitted by the authorization, and/or other limit(s)). In some embodiments, the validation unit may be configured to validate a triggered transmission based on time. For example, the validation unit may determine whether the triggered transmission was triggered prior to an expiry timepoint of the authorization.

After the first user is granted the authorization, process 1800 proceeds to step 1808 where the validation units determine whether an authorization has ended. In some embodiments, a validation unit may be configured to determine whether the authorization has ended by determining whether a current time is passed an expiry timepoint of the authorization (e.g., of an authorization hold). The validation unit may determine the authorization to have ended after the expiry timepoint. In some embodiments, a validation unit may be configured to determine whether the authorization has ended based on an amount of the UTM that has been transmitted by the first user from a UTM balance of the second user. For example, the validation unit may determine whether the transmitted amount has reached a held amount of the UTM, reached a maximum allowed amount of the UTM, or reached another limit. The validation unit may be configured to determine that the authorization has ended when the amount of the UTM that has been transmitted by the first user from the UTM balance of the second user meets a limit.

If at step 1808, it is determined that the authorization is not to end, then process 1800 returns to step 1806 where the authorization continues to remain in place for the first user to trigger transmissions from the second user. If at step 1808 it is determined that the authorization is to be ended by the validation units, then process 1800 proceeds to step 1810 where the authorization for the first user is ended. In some embodiments, the validation units may be configured to revoke the authorization. For example, the validation units may mark the authorization has expired. The first user may longer be allowed to authorized to trigger transmissions from the second user under the authorization.

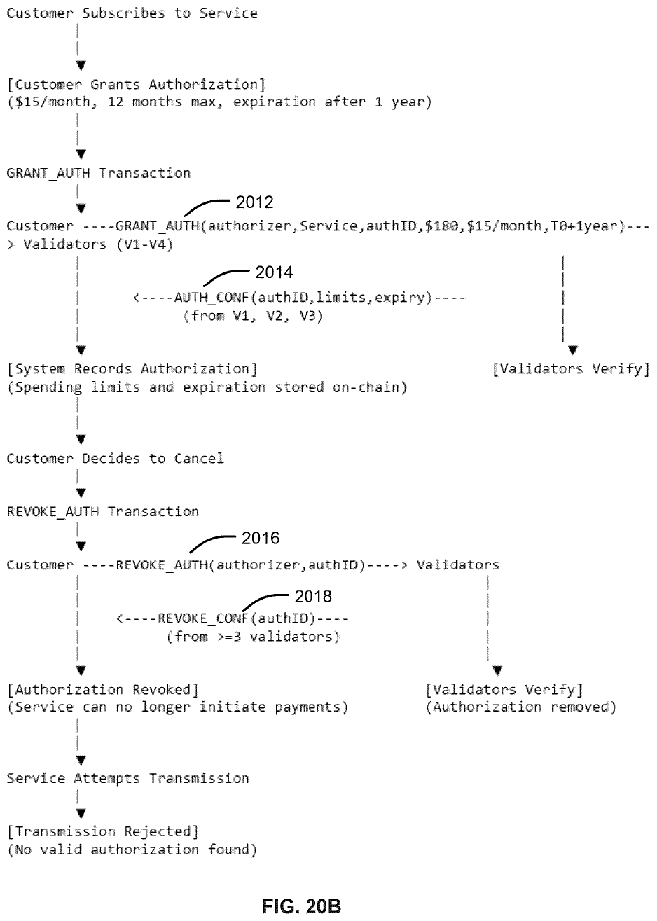

FIG. 19 shows a flowchart of an example process 1900 for a user of a data transmission system to authorize another user to perform transmissions on behalf of the user, according to some embodiments of the technology described herein. Process 1900 may be performed by a user device of a data transmission system or another device in the data transmission system. For example, process 1900 may be performed by the user 1702A of data transmission system 1700 to grant the user 1702B authorization to trigger UTM balances from a UTM balance of the user 1702A. As another example, the process 1900 may be performed by a device on behalf of the user 1702A.

Process 1900 begins at step 1902, where the system performing process 1900 transmits, to validation units of the data transmission system (e.g., validation units 1710A, 1710B, 1710C described herein with reference to FIGS. 17A-17B), an authorization for a first user to trigger UTM transmissions from one or more UTM balances of a second user. In some embodiments, the system may be configured to transmit the authorization by transmitting an authorization message specifying parameters (e.g., parameters indicating limits, authorized amounts, authorized UTM balance(s), expiry timepoint, and/or other parameters) of the authorization. Example authorization messages and parameters are described herein. The authorization may be validated by the validation units (e.g., by performing process 1800 described herein with reference to FIG. 18).

Next, process 1900 proceeds to step 1904, where the system receives validation messages from the validation units. If the system does not receive a threshold number of validation messages from the validation units indicating that the authorization is valid, then process 1900 ends and the first user is not granted the authorization. If the system receives a threshold number of validation messages from the validation units at step 1904, then process 1900 proceeds to step 1906, where the first user is granted the authorization to trigger transmissions from the UTM balance(s) of the second user. In some embodiments, the system may be configured to generate an authentication validation certificate using validation signatures received from the validation units. The authentication validation certificate may indicate that the threshold number of validation units have validated the authorization. The system may be configured to transmit the certificate to the validation units (e.g., for recording in their respective memories and for use in validating transmissions triggered by the first user from the UTM balance(s) of the second user).

In some embodiments, the system may be configured to transmit a modification to the authorization. For example, the system may transmit a modification to a permission configuration of the authorization that specifies limit(s) to the authorization. To illustrate, the modification may change a maximum UTM amount that can be transmitted, a maximum UTM amount that can be transmitted over a time period, and/or an expiry timepoint of the authorization. The system may be configured to transmit the modification to the validation units for verification. When the modification is validated by a threshold number of validation units, the modification may be applied to the authorization. For example, the system may generate a certificate using validation signatures from the validation units indicating that the modification is valid. The system may transmit the certificate to the validation units to cause the validation units to apply the modification to the authorization.

While the authorization is granted to the first user, the first user may trigger transmissions from the UTM balance(s) of the second user. Example techniques for the first user to trigger transmissions and validation of those transmissions are described herein with reference to FIGS. 17A-17B. In some embodiments, the first user may trigger transmissions using a nonce of the second user (to maintain serial order of transmissions from the UTM balance(s) of the second user). The first user may query the second user device for a current nonce of the second user. In some embodiments, the first user may trigger transmissions using the first user's own nonce (e.g., by incrementing the nonce). In some embodiments, the first user may trigger transmissions using a global nonce (e.g., by incrementing the global nonce).

Next, process 1900 proceeds to step 1908, where the system determines whether the authorization is to end. In some embodiments, the system may determine whether an authorization is to end based on time and/or amount of UTM transmissions made by the user. For example, the system may determine that an expiry timepoint of the authorization (e.g., an authorization hold) has passed. As another example, the system may determine that transmission(s) by the first user meet limit(s) of the authorization. If the system does not determine that the authorization is to end at step 1908, then process 1900 returns to step 1906 where the authorization remains active. If the system determines that the authorization is to end at step 1908, then process 1900 proceeds to step 1910 where the system ends the authorization of the first user to trigger UTM transmissions from the UTM balance(s) of the second user. In some embodiments, the system may be configured to transmit a message to the validation units ending the authorization. In some embodiments, the authorization may automatically be ended/revoked by the validation units (e.g., without any command or message from the system performing process 1900).

### Example Authorization Flows

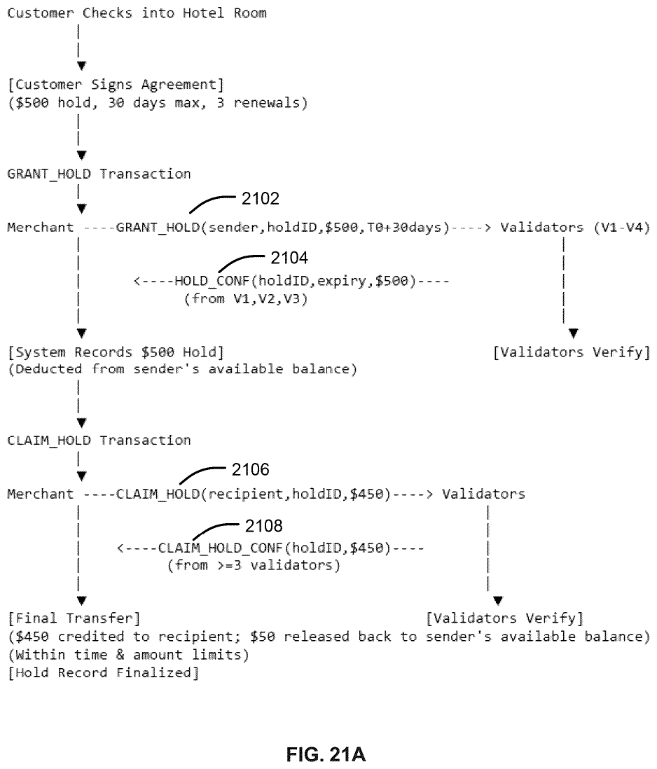

FIG. 20A illustrates a flow of an example authorization that is granted by an authorizing user and then used to trigger a transmission by the authorized user, according to some embodiments of the technology described herein. In the example authorization of FIG. 20A, a customer (i.e., the authorizing user) subscribes to a service (the authorized user). Accordingly, the customer grants an authorization to the service to trigger transmissions from a UTM balance of the customer. In the example of FIG. 20A, the UTM balance may represent an amount of USD belonging to the customer. The authorization allows the service to trigger a transmission of $15 per month for 12 months. The customer transmits, to validators V1-V4, an authorization message 2002. The authorization message 2002 specifies the authorizer, the service, an authorization ID, a maximum amount of $180 that can be triggered for transmission by the service, a limit of $15 per month that can be triggered for transmission by the service, and a time that the authorization lasts of one year from a current time (TO). The validators validate the information in the authorization message 2002 and transmit validation messages 2004 to the customer. The system then records the authorization (including limits and expiration information). For example, the customer may generate an authorization validation certificate using the validation messages 2004 and transmit the authorization validation certificate to the validators for recording in respective transmission records (e.g., copies of a chain).

After the authorization is granted to the service, the service then initiates transmission(s) from the UTM balance of the customer. The service sends a transmission message 2006 to the validators specifying an authorization ID and an amount to be transmitted. The validators verify the transmission based on time and amount limits of the authorization (e.g., that were recorded by the validators on-chain). When the validators verify the parameters of the transmission, the validators transmit validation messages 2008 to the service. When the service receives a threshold number of validators, the transmission may be validated and executed. For example, the service may generate a validation certificate and transmit it to the validators to cause the validators to update UTM balances of the customer and the service to reflect the transmission (e.g., by decreasing the UTM balance of the customer by $15 and increasing the UTM balance of the service by $15). In this example, the authorization remains active after the transmission because the transmission amount and time limits have not been reached.

FIG. 20B illustrates a flow of an example authorization that is granted and then revoked, according to some embodiments of the technology described herein. In the example authorization of FIG. 20B, a customer (i.e., the authorizing user) subscribes to a service (the authorized user). Accordingly, the customer grants an authorization to the service to trigger transmissions from a UTM balance of the customer. In the example of FIG. 20B, the UTM balance may represent an amount of USD belonging to the customer. The authorization allows the service to trigger a transmission of $15 per month for 12 months. The customer transmits the authorization message 2012 to the validators. The authorization message 2012 specifies the authorizer, the service, an authorization ID, a maximum amount of $180 that can be triggered for transmission by the service, a limit of $15 per month that can be triggered for transmission by the service, and a time that the authorization lasts of one year from a current time (TO). The validators validate the information in the authorization message 2012 and transmit validation messages 2014 to the customer. The system then records the authorization (including limits and expiration information). For example, the customer may generate an authorization validation certificate using the validation messages 2014 and transmit the authorization validation certificate to the validators for recording in respective transmission records (e.g., copies of a chain).

After the authorization is granted, the customer decides to cancel the subscription to the service. The customer transmits an authorization revocation message 2016 to the validators. The message 2016 includes an indication of the authorizer and an authorization ID of the authorization being revoked. The validators validate the revocation and transmit validation messages 2018 to the customer indicating that the revocation is valid. When the customer receives validation messages from a threshold number of validation units, the authorization is revoked. For example, the customer may generate an authorization revocation certificate using the validation messages, and send the authorization revocation certificate to the validation units. The validation units may thus no longer allow transmissions by the service from the UTM balance of the customer. As shown in FIG. 20B, the service attempts to trigger a transmission but it is rejected by the validators.

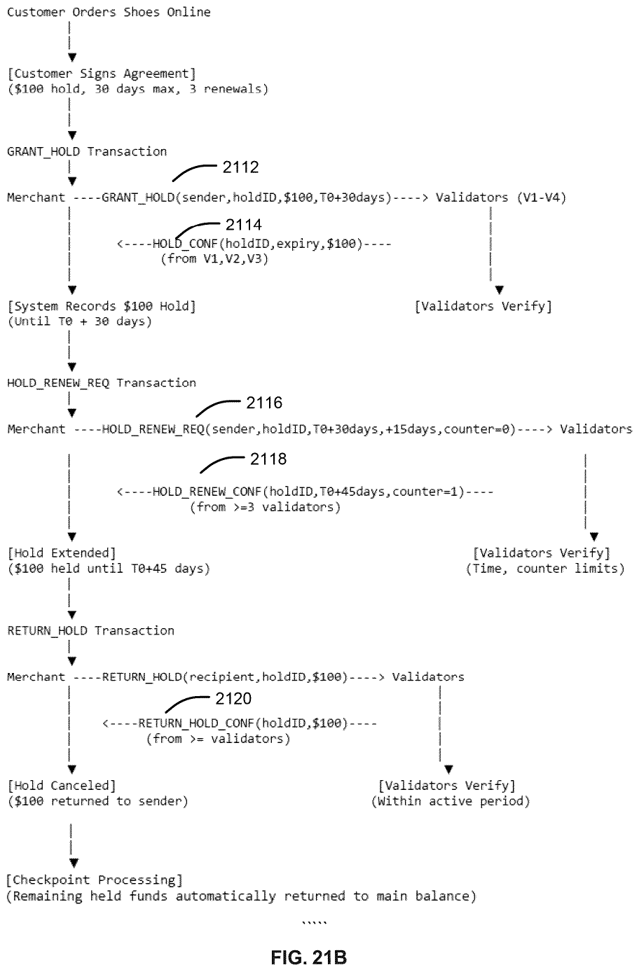

FIG. 21A illustrates a flow of an example authorization that is granted and then used to trigger a transmission, according to some embodiments of the technology described herein. In the example authorization of FIG. 21A, a customer (i.e., the authorizing user) signs an agreement with a merchant (the authorized user) for booking a hotel room. In the example of FIG. 21A, the UTM balance may represent an amount of USD belonging to the customer. The authorization allows the merchant to trigger transmissions totaling $500 for a period of 30 days. The merchant transmits, to validators V1-V4, an authorization message 2102 to obtain the authorization hold. The authorization message 2102 specifies the sender, an authorization hold ID, a maximum amount of $500 that can be triggered for transmission, and a time that the authorization lasts 30 days from a current time (TO). The validators validate the information in the authorization message 2102 and transmit validation messages 2104 to the merchant. The system then records the authorization hold (including limit and expiration information). For example, the merchant may generate an authorization validation certificate using the validation messages 2104 and transmit the authorization validation certificate to the validators for recording in respective transmission records (e.g., copies of a chain).

After the authorization is granted to the merchant, the merchant then initiates transmission(s) from the UTM balance of the customer. The merchant sends a transmission message 2106 to the validators specifying an authorization hold ID and an amount of $450 to be transmitted. The validators verify the transmission based on time and amount limits of the authorization (e.g., that were recorded by the validators on-chain). When the validators verify the parameters of the transmission, the validators transmit validation messages 2108 to the merchant. When the merchant receives a threshold number of validators, the transmission may be validated and executed. For example, the merchant may generate a validation certificate and transmit it to the validators to cause the validators to update UTM balances of the customer and the merchant to reflect the transmission (e.g., by decreasing the UTM balance of the customer by $450 and increasing the UTM balance of the merchant by $450). In this example, the authorization time expires and the remaining $50 that was held is returned to the customer.

FIG. 21B illustrates a flow of an example authorization that is renewed and then canceled, according to some embodiments of the technology described herein. In the example authorization of FIG. 21B, a customer (i.e., the authorizing user) signs an agreement with a merchant (the authorized user) for ordering shoes online. In the example of FIG. 21B, the UTM balance may represent an amount of USD belonging to the customer. The authorization allows the merchant to trigger transmissions totaling $100 for a period of 30 days, with a maximum of 3 renewals. The merchant transmits, to validators V1-V4, an authorization message 2112 to obtain the authorization hold. The authorization message 2112 specifies the sender, an authorization hold ID, a maximum amount of $100 that can be triggered for transmission, and a time that the authorization lasts 30 days from a current time (TO). The validators validate the information in the authorization message 2112 and transmit validation messages 2114 to the merchant. The system then records the authorization hold (including limit and expiration information). For example, the merchant may generate an authorization validation certificate using the validation messages 2114 and transmit the authorization validation certificate to the validators for recording in respective transmission records (e.g., copies of a chain).

After the authorization hold is granted to the merchant, the merchant requests renewal of the authorization hold. The merchant sends a message 2116 to the validators requesting an extension of 15 days to the authorization hold. The validators validate the extension and transmit validation messages 2118 to the merchant. The authorization hold is then extended by 15 days when a threshold number of the validators have validated the extension. For example, the merchant may generate an extension certificate and transmit the certificate to the validators to cause them to record the extension to the authorization hold. In the example of FIG. 21B, the transaction between the customer and the merchant is canceled. Thus, the merchant transmits, to the validators, a message 2120 triggering return of the held amount back to the customer. The validators validate the return and transmit validation messages to the merchant indicating that the return is valid. The held amount of $100 is then returned to the UTM balance of the customer.

### Example Specially Configurable Computer System

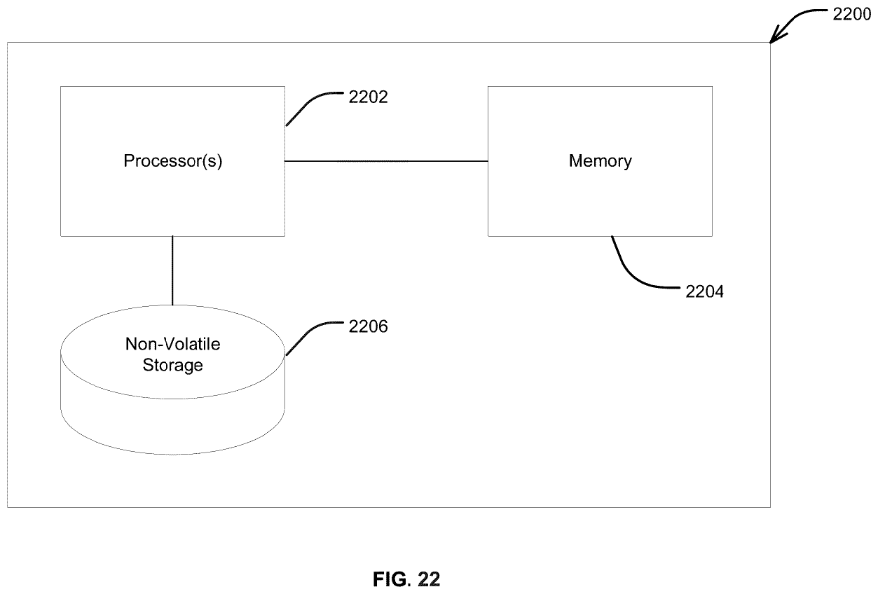

FIG. 22 is an example computer system 2200 that may be specially configured to perform embodiments of the technology described herein. The computing device 2200 may include one or more computer hardware processors 2202 and non-transitory computer-readable storage media (e.g., memory 2204 and one or more non-volatile storage 2204). The processor(s) 2202 may control writing data to and reading data from (1) the memory 2204; and (2) the non-volatile storage device(s) 2206. To perform any of the functionality described herein, the processor(s) 2202 may execute one or more processor-executable instructions stored in one or more non-transitory computer-readable storage media (e.g., the memory 2204), which may serve as non-transitory computer-readable storage media storing processor-executable instructions for execution by the processor(s) 2202.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

### Summary of Example Embodiments

In some aspects, the techniques described herein relate to a method for asynchronously allowing a user of a data transmission system to authorize another user to perform transmissions of a uniform transmission medium (UTM) from a UTM balance of the user, the data transmission system including validation units for validating transmissions among users of the data transmission system, the method including: using at least one processor to perform: transmitting, to the validation units, an authorization for a first user to trigger UTM transmissions in the data transmission system from a UTM balance of a second user; receiving, from at least some of the validation units, validation messages indicating that the authorization for the first user to perform UTM transmissions from the UTM balance of the second user is valid, wherein: when validation messages are received from at least a threshold number of the validation units, the first user is granted the authorization to trigger UTM transmissions from the UTM balance of the second user.

In some aspects, the techniques described herein relate to a method, further including: when the validation messages are received from at least the threshold number of the validation units: generating, using the validation messages, an authorization certificate; and transmitting the authorization certificate to the validation units to grant the first user the authorization to trigger UTM transmissions from the UTM balance of the second user.

In some aspects, the techniques described herein relate to a method, further including performing, by each of the at least some validation units: receiving the authorization for the first user to perform UTM transmissions in the data transmission system from the UTM balance of the second user; determining whether the authorization is valid; in response to determining that the authorization is valid: cryptographically signing a message with a validation signature indicating that the requested authorization is valid to generate a validation message; and transmitting, to the first user, the validation message including the validation signature.

In some aspects, the techniques described herein relate to a method, wherein when the first user is granted the authorization to trigger UTM transmissions from the UTM balance of the second user: recording, by the validation units, in transmission records stored in memories of the validation units, a record of the authorization granted to the first user.

In some aspects, the techniques described herein relate to a method, wherein the transmission records stored in the memories of the validation units include block chains.

In some aspects, the techniques described herein relate to a method, wherein transmitting, to the validation units, the authorization includes transmitting a permission configuration for the authorization, the permission configuration specifying one or more limits to the UTM transmissions that can be triggered by the first user from the UTM balance of the second user.

In some aspects, the techniques described herein relate to a method, wherein the one or more limits include at least one of: a maximum amount of the UTM that can be transmitted by the first user from the UTM balance of the second user; a maximum amount of the UTM that can be transmitted by the first user from the UTM balance of the second user over a time period; or an expiry timepoint for the authorization.

In some aspects, the techniques described herein relate to a method, further including using the at least one processor to perform: transmitting, to the validation units, a modification to the permission configuration for the authorization; receiving, from at least some of the validation units, validation messages indicating that the modification to the permission configuration is valid, wherein: when validation messages indicating that the modification to the permission configuration is valid are received from at least the threshold number of the validation units, the modification is applied to the permission configuration for the authorization.

In some aspects, the techniques described herein relate to a method, further including using the at least one processor to perform: transmitting, to the validation units, a cancellation of the authorization granted to the first user; receiving, from at least some of the validation units, validation messages indicating that the cancellation to the authorization granted to the first user is valid, wherein: when validation messages indicating that the cancellation is valid are received from at least the threshold number of the validation units, the authorization granted to the first user is revoked.

In some aspects, the techniques described herein relate to a method, wherein the method further includes: after the first user is granted the authorization to trigger UTM transmissions from the UTM balance of the second user, triggering a first UTM transmission from the UTM balance of the second user.

In some aspects, the techniques described herein relate to a method, wherein: the second user has an associated nonce that is incremented with each transmission from the UTM balance of the second user; and triggering the first UTM transmission from the UTM balance of the second user includes: querying a device associated with the second user for a current nonce of the second user; and triggering the first UTM transmission from the UTM balance of the second user using the current nonce of the user.

In some aspects, the techniques described herein relate to a method, wherein triggering the first UTM transmission from the UTM balance of the second user using the current nonce of the second user includes: transmitting, to the validation units, a request for the first UTM transmission including the current nonce of the second user, wherein the method further includes validating, by the validating units, the first UTM transmission using the current nonce of the second user.

In some aspects, the techniques described herein relate to a method, wherein: the first user has an associated nonce that is incremented with each transmission from the UTM balance of the second user; and triggering the first UTM transmission from the UTM balance of the second user comprises: querying a device associated with the first user for a current nonce of the first user; and triggering the first UTM transmission from the UTM balance of the second user using the current nonce of the first user.

In some aspects, the techniques described herein relate to a non-transitory storage medium storing instructions that, when executed by at least one processor, cause the at least one processor to perform a method for asynchronously allowing a user of a data transmission system to authorize another user to perform transmissions of a uniform transmission medium (UTM) from a UTM balance of the user, the data transmission system including validation units for validating transmissions among users of the data transmission system, the method including: transmitting, to the validation units, an authorization for a first user to trigger UTM transmissions in the data transmission system from a UTM balance of a second user; receiving, from at least some of the validation units, validation messages indicating that the authorization for the first user to perform UTM transmissions from the UTM balance of the second user is valid, wherein: when validation messages are received from at least a threshold number of the validation units, the first user is granted the authorization to trigger UTM transmissions from the UTM balance of the second user.

In some aspects, the techniques described herein relate to a non-transitory storage medium, wherein the method further includes: when the validation messages are received from at least the threshold number of the validation units: generating, using the validation messages, an authorization certificate; and transmitting the authorization certificate to the validation units to grant the first user the authorization to trigger UTM transmissions from the UTM balance of the second user.

In some aspects, the techniques described herein relate to a non-transitory storage medium, wherein the method further includes performing, by each of the at least some validation units: receiving the authorization for the first user to perform UTM transmissions in the data transmission system from the UTM balance of the second user; determining whether the authorization is valid; in response to determining that the authorization is valid: cryptographically signing a message with a validation signature indicating that the requested authorization is valid to generate a validation message; and transmitting, to the first user, the validation message including the validation signature.

In some aspects, the techniques described herein relate to a non-transitory storage medium, wherein the method further includes: when the first user is granted the authorization to trigger UTM transmissions from the UTM balance of the second user: recording, by the validation units, in transmission records stored in memories of the validation units, a record of the authorization granted to the first user.

In some aspects, the techniques described herein relate to a non-transitory storage medium, wherein transmitting, to the validation units, the authorization includes transmitting a permission configuration for the authorization, the permission configuration specifying one or more limits to the UTM transmissions that can be triggered by the first user from the UTM balance of the second user.

In some aspects, the techniques described herein relate to a non-transitory storage medium, wherein the method further includes: transmitting, to the validation units, a cancellation of the authorization granted to the first user; receiving, from at least some of the validation units, validation messages indicating that the cancellation to the authorization granted to the first user is valid, wherein: when validation messages indicating that the cancellation is valid are received from at least the threshold number of the validation units, the authorization granted to the first user is revoked.

In some aspects, the techniques described herein relate to a system for asynchronously allowing a user of a data transmission system to authorize another user to perform transmissions of a uniform transmission medium (UTM) from a UTM balance of the user, the data transmission system including validation units for validating transmissions among users of the data transmission system, the system including: at least one processor; and a non-transitory computer-readable storage medium storing instructions that, when executed by the at least one processor, cause the at least one processor to: transmit, to the validation units, an authorization for a first user to trigger UTM transmissions in the data transmission system from a UTM balance of a second user; receive, from at least some of the validation units, validation messages indicating that the authorization for the first user to perform UTM transmissions from the UTM balance of the second user is valid, wherein: when validation messages are received from at least a threshold number of the validation units, the first user is granted the authorization to trigger UTM transmissions from the UTM balance of the second user.

In some aspects, the techniques described herein relate to a system, wherein the instructions further cause that least one processor to: when the validation messages are received from at least the threshold number of the validation units: generate, using the validation messages, an authorization certificate; and transmit the authorization certificate to the validation units to grant the first user the authorization to trigger UTM transmissions from the UTM balance of the second user.

In some aspects, the techniques described herein relate to a method for asynchronously authorizing holds on uniform transmission medium (UTM) balances of users of a data transmission system, the data transmission system including validation units for validating transmissions among the users, the method including: receiving, by the validation units, an authorization for a first user to trigger UTM transmissions from a UTM balance of a second user, the authorization including an indication of: (1) an amount of the UTM authorized for transmission from the second user, and (2) an expiry timepoint when authorization to trigger the transmissions expires; determining, by the validation units, whether the authorization is valid based on the amount of the UTM authorized for transmission; when the authorization is determined to be valid by at least a threshold number of the validation units: authorizing, by the validation units, the first user to trigger UTM transmissions from the UTM balance of the second user to the first user up to the authorized amount of the UTM until the expiry timepoint.

In some aspects, the techniques described herein relate to a method, further including: when the authorization is determined to be valid by at least the threshold number of the validation units: locking, by the validation units, the amount of the UTM in a UTM balance associated with the second user stored in respective memories of the validation units, wherein locked UTM in the UTM balance is prevented from being transmitted to any user other than the first user until the expiry timepoint.

In some aspects, the techniques described herein relate to a method, further including: after authorizing the first user to trigger UTM transmissions until the expiry timepoint: receiving, by the validation units, a request by the first user to trigger one or more UTM transmissions from the UTM balance of the second user to the first user; determining, by the validation units, whether the one or more UTM transmissions are valid; and when the one or more UTM transmissions are determined to be valid by the threshold number of validation units, executing the one or more UTM transmissions from the UTM balance of the second user.

In some aspects, the techniques described herein relate to a method, wherein determining, by the validation units, whether the one or more UTM transmissions are valid includes: determining whether an amount of UTM in the one or more UTM transmissions is less than the amount of UTM authorized for transmission.

In some aspects, the techniques described herein relate to a method, wherein determining, by the validation units, whether the one or more UTM transmissions are valid includes: determining whether a time when the one or more UTM transmissions were triggered is prior to the expiry timepoint indicated by the authorization request.

In some aspects, the techniques described herein relate to a method, further including: after authorizing the first user to trigger UTM transmissions until the expiry timepoint: determining that a current time has passed the expiry timepoint indicated by the authorization request; and in response to determining that the current time has passed the expiry timepoint, revoking authorization for the first user to trigger UTM transmissions from the UTM balance of the second user.

In some aspects, the techniques described herein relate to a method, further including: after determining that the current time has passed the expiry timepoint indicated by the authorization request: determining, by the validation units, a remaining amount of the UTM that was not transmitted from the UTM balance of the second user while the first user was authorized to trigger the UTM transmissions; and returning, by the validation units, the remaining amount of the UTM to a UTM balance of the second user.

In some aspects, the techniques described herein relate to a method, further including: after authorizing the first user to trigger UTM transmissions from the UTM balance eof the second user: receiving, by the validation units, an extension to the expiry timepoint indicated by the authorization request; determining, by the validation units, whether the extension to the expiry timepoint is valid; and when the extension to the expiry timepoint is determined to be valid by at least the threshold number of validation units, extending the expiry timepoint based on the requested extension.

In some aspects, the techniques described herein relate to a method, wherein: the authorization request further indicates a maximum number of extensions that can be applied to the expiry timepoint; and determining, by the validation units, whether the extension to the expiry timepoint is valid includes determining whether the maximum number of extensions have already been applied to the expiry timepoint.

In some aspects, the techniques described herein relate to a method, wherein: the authorization further indicates a maximum amount of time for the first user to be authorized to trigger the UTM transmissions; and determining, by the validation units, whether the extension to the expiry timepoint is valid includes determining whether the extension to the expiry timepoint would authorize the first user to trigger the transmissions for longer than the maximum amount of time.

In some aspects, the techniques described herein relate to a method, wherein: the authorization further indicates a first UTM balance of a plurality of UTM balances associated with the second user; and authorizing the first user to trigger UTM transmissions from the UTM balance of the second user includes authorizing the first user to trigger UTM transmissions from the first UTM balance.

In some aspects, the techniques described herein relate to a method, wherein authorizing, by the validation units, the first user to trigger UTM transmissions from the UTM balance of the second user up to the authorized amount of the UTM until the expiry timepoint includes: receiving a validation certificate indicating that the authorization has been validated by the threshold number of validation units; and recording, in respective transmission records stored in memories of the validation units, a record of the authorization.

In some aspects, the techniques described herein relate to a method, further including: receiving, by a device of the data transmission system, an inquiry by the first user for authorizations granted to the first user; in response to receiving the inquiry, transmitting, to a device associated with the first user, an indication of one or more authorizations granted to the first user, the one or more authorizations including the authorization for the first user to trigger UTM transmissions from the UTM balance of the second user.

In some aspects, the techniques described herein relate to a method, further including: after authorizing the first user to trigger UTM transmissions from the UTM balance of the second user: receiving, by the validation units from the first user, a request for a transmission from the UTM balance of the second user, the request including a current nonce associated with the first user and/or a current nonce associated with the second user; and validating, by the validation units, the transmission using the current nonce associated with the first user and/or the current nonce associated with the second user.

In some aspects, the techniques described herein relate to a non-transitory storage medium storing instructions that, when executed by processors of validation units of a data transmission system, cause the validation units to perform a method for asynchronously authorizing holds on uniform transmission medium (UTM) balances of users of the data transmission system, the method including: receiving, by the validation units, an authorization for a first user to trigger UTM transmissions from a UTM balance of a second user, the authorization including an indication of: (1) an amount of the UTM authorized for transmission from the second user, and (2) an expiry timepoint when authorization to trigger the transmissions expires; determining, by the validation units, whether the authorization is valid based on the amount of the UTM authorized for transmission; when the authorization is determined to be valid by at least a threshold number of the validation units: authorizing, by the validation units, the first user to trigger UTM transmissions from the UTM balance of the second user to the first user up to the authorized amount of the UTM until the expiry timepoint.

In some aspects, the techniques described herein relate to a non-transitory storage medium, wherein the method further includes: when the authorization is determined to be valid by at least the threshold number of the validation units: locking, by the validation units, the amount of the UTM in a UTM balance associated with the second user stored in respective memories of the validation units, wherein locked UTM in the UTM balance is prevented from being transmitted to any user other than the first user until the expiry timepoint.

In some aspects, the techniques described herein relate to a non-transitory storage medium, wherein the method further includes: after authorizing the first user to trigger UTM transmissions until the expiry timepoint: receiving, by the validation units, a request by the first user to trigger one or more UTM transmissions from the UTM balance of the second user to the first user; determining, by the validation units, whether the one or more UTM transmissions are valid; and when the one or more UTM transmissions are determined to be valid by the threshold number of validation units, executing the one or more UTM transmissions from the UTM balance of the second user.

In some aspects, the techniques described herein relate to a non-transitory storage medium, wherein the method further includes: after authorizing the first user to trigger UTM transmissions until the expiry timepoint: determining that a current time has passed the expiry timepoint indicated by the authorization request; and in response to determining that the current time has passed the expiry timepoint, revoking authorization for the first user to trigger UTM transmissions from the UTM balance of the second user.

In some aspects, the techniques described herein relate to a non-transitory storage medium, wherein the method further includes: after authorizing the first user to trigger UTM transmissions from the UTM balance eof the second user: receiving, by the validation units, an extension to the expiry timepoint indicated by the authorization request; determining, by the validation units, whether the extension to the expiry timepoint is valid; and when the extension to the expiry timepoint is determined to be valid by at least the threshold number of validation units, extending the expiry timepoint based on the requested extension.

In some aspects, the techniques described herein relate to a data transmission system for asynchronously authorizing holds on uniform transmission medium (UTM) balances of users of the data transmission system, the data transmission system including: validation units including respective processors, the validation units configured to: receive authorization for a first user to trigger UTM transmissions from a UTM balance of a second user, the authorization including an indication of: (1) an amount of the UTM authorized for transmission from the second user, and (2) an expiry timepoint when authorization to trigger the transmissions expires; determine whether the authorization is valid based on the amount of the UTM authorized for transmission; when the authorization is determined to be valid by at least a threshold number of the validation units: authorize the first user to trigger UTM transmissions from the UTM balance of the second user to the first user up to the authorized amount of the UTM until the expiry timepoint.

In some aspects, the techniques described herein relate to a system, wherein the validation units are further configured to: when the authorization is determined to be valid by at least the threshold number of the validation units: lock the amount of the UTM in a UTM balance associated with the second user stored in respective memories of the validation units, wherein locked UTM in the UTM balance is prevented from being transmitted to any user other than the first user until the expiry timepoint.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A method for asynchronously allowing a user of a data transmission system to authorize another user to perform transmissions of a uniform transmission medium (UTM) from a UTM balance of the user, the data transmission system comprising validation units for validating transmissions among users of the data transmission system, the method comprising:
using at least one processor to perform:
transmitting, to the validation units, an authorization for a first user to trigger UTM transmissions in the data transmission system from a UTM balance of a second user; and
receiving, from at least some of the validation units, validation messages indicating that the authorization for the first user to perform UTM transmissions from the UTM balance of the second user is valid, wherein:
when validation messages are received from at least a threshold number of the validation units, the first user is granted the authorization to trigger UTM transmissions from the UTM balance of the second user.

2. The method of claim 1, further comprising:
when the validation messages are received from at least the threshold number of the validation units:
generating, using the validation messages, an authorization certificate; and
transmitting the authorization certificate to the validation units to grant the first user the authorization to trigger UTM transmissions from the UTM balance of the second user.

3. The method of claim 1, further comprising performing, by each of the at least some validation units:
receiving the authorization for the first user to perform UTM transmissions in the data transmission system from the UTM balance of the second user;
determining whether the authorization is valid;
in response to determining that the authorization is valid:
cryptographically signing a message with a validation signature indicating that the requested authorization is valid to generate a validation message; and
transmitting, to the first user, the validation message including the validation signature.

4. The method of claim 1, wherein when the first user is granted the authorization to trigger UTM transmissions from the UTM balance of the second user:
recording, by the validation units, in transmission records stored in memories of the validation units, a record of the authorization granted to the first user.

5. The method of claim 4, wherein the transmission records stored in the memories of the validation units comprise block chains.

6. The method of claim 1, wherein transmitting, to the validation units, the authorization comprises transmitting a permission configuration for the authorization, the permission configuration specifying one or more limits to the UTM transmissions that can be triggered by the first user from the UTM balance of the second user.

7. The method of claim 6, wherein the one or more limits include at least one of:
a maximum amount of the UTM that can be transmitted by the first user from the UTM balance of the second user;
a maximum amount of the UTM that can be transmitted by the first user from the UTM balance of the second user over a time period; or
an expiry timepoint for the authorization.

8. The method of claim 6, further comprising using the at least one processor to perform:
transmitting, to the validation units, a modification to the permission configuration for the authorization;
receiving, from at least some of the validation units, validation messages indicating that the modification to the permission configuration is valid, wherein:
when validation messages indicating that the modification to the permission configuration is valid are received from at least the threshold number of the validation units, the modification is applied to the permission configuration for the authorization.

9. The method of claim 1, further comprising using the at least one processor to perform:
transmitting, to the validation units, a cancellation of the authorization granted to the first user;
receiving, from at least some of the validation units, validation messages indicating that the cancellation to the authorization granted to the first user is valid, wherein:
when validation messages indicating that the cancellation is valid are received from at least the threshold number of the validation units, the authorization granted to the first user is revoked.

10. The method of claim 1, wherein the method further comprises:
after the first user is granted the authorization to trigger UTM transmissions from the UTM balance of the second user, triggering a first UTM transmission from the UTM balance of the second user.

11. The method of claim 10, wherein:
the second user has an associated nonce that is incremented with each transmission from the UTM balance of the second user; and
triggering the first UTM transmission from the UTM balance of the second user comprises:
querying a device associated with the second user for a current nonce of the second user; and
triggering the first UTM transmission from the UTM balance of the second user using the current nonce of the second user.

12. The method of claim 11, wherein triggering the first UTM transmission from the UTM balance of the second user using the current nonce of the second user comprises:
transmitting, to the validation units, a request for the first UTM transmission including the current nonce of the second user, wherein the method further comprises validating, by the validating units, the first UTM transmission using the current nonce of the second user.

13. The method of claim 10, wherein:
the first user has an associated nonce that is incremented with each transmission from the UTM balance of the second user; and
triggering the first UTM transmission from the UTM balance of the second user comprises:
querying a device associated with the first user for a current nonce of the first user; and
triggering the first UTM transmission from the UTM balance of the second user using the current nonce of the first user.

14. A non-transitory storage medium storing instructions that, when executed by at least one processor, cause the at least one processor to perform a method for asynchronously allowing a user of a data transmission system to authorize another user to perform transmissions of a uniform transmission medium (UTM) from a UTM balance of the user, the data transmission system comprising validation units for validating transmissions among users of the data transmission system, the method comprising:
transmitting, to the validation units, an authorization for a first user to trigger UTM transmissions in the data transmission system from a UTM balance of a second user;
receiving, from at least some of the validation units, validation messages indicating that the authorization for the first user to perform UTM transmissions from the UTM balance of the second user is valid, wherein:
when validation messages are received from at least a threshold number of the validation units, the first user is granted the authorization to trigger UTM transmissions from the UTM balance of the second user.

15. The non-transitory storage medium of claim 14, wherein the method further comprises:
when the validation messages are received from at least the threshold number of the validation units:
generating, using the validation messages, an authorization certificate; and
transmitting the authorization certificate to the validation units to grant the first user the authorization to trigger UTM transmissions from the UTM balance of the second user.

16. The non-transitory storage medium of claim 14, wherein the method further comprises performing, by each of the at least some validation units:
receiving the authorization for the first user to perform UTM transmissions in the data transmission system from the UTM balance of the second user;
determining whether the authorization is valid;
in response to determining that the authorization is valid:
cryptographically signing a message with a validation signature indicating that the requested authorization is valid to generate a validation message; and
transmitting, to the first user, the validation message including the validation signature.

17. The non-transitory storage medium of claim 14, wherein the method further comprises:
when the first user is granted the authorization to trigger UTM transmissions from the UTM balance of the second user:
recording, by the validation units, in transmission records stored in memories of the validation units, a record of the authorization granted to the first user.

18. The non-transitory storage medium of claim 14, wherein transmitting, to the validation units, the authorization comprises transmitting a permission configuration for the authorization, the permission configuration specifying one or more limits to the UTM transmissions that can be triggered by the first user from the UTM balance of the second user.

19. A system for asynchronously allowing a user of a data transmission system to authorize another user to perform transmissions of a uniform transmission medium (UTM) from a UTM balance of the user, the data transmission system comprising validation units for validating transmissions among users of the data transmission system, the system comprising:
at least one processor; and
a non-transitory computer-readable storage medium storing instructions that, when executed by the at least one processor, cause the at least one processor to:
transmit, to the validation units, an authorization for a first user to trigger UTM transmissions in the data transmission system from a UTM balance of a second user;
receive, from at least some of the validation units, validation messages indicating that the authorization for the first user to perform UTM transmissions from the UTM balance of the second user is valid, wherein:
when validation messages are received from at least a threshold number of the validation units, the first user is granted the authorization to trigger UTM transmissions from the UTM balance of the second user.

20. The system of claim 19, wherein the instructions further cause that least one processor to:
when the validation messages are received from at least the threshold number of the validation units:
generate, using the validation messages, an authorization certificate; and
transmit the authorization certificate to the validation units to grant the first user the authorization to trigger UTM transmissions from the UTM balance of the second user.
